(19) United States
(12) Patent Application Publication
(10) Pub. No.: US 2025/0358267 A1
(43) Pub. Date: Nov. 20, 2025

(54) Electronic device for wireless communication, and operational method thereof

(71) Applicant: Samsung Electronics Co., Ltd., Suwon-si (KR)

(72) Inventors: Sangmook KIM, Suwon-si (KR); Dongho LIM, Suwon-si (KR); Ahyoung CHO, Suwon-si (KR); Seunghwan HWANG, Suwon-si (KR)

(21) Appl. No.: 19/291,058

(22) Filed: Aug. 5, 2025

Related U.S. Application Data
(63) Continuation of application No. PCT/KR2024/095058, filed on Jan. 26, 2024.

(30) Foreign Application Priority Data
Feb. 7, 2023 (KR) 10-2023-0015925
Mar. 9, 2023 (KR) 10-2023-0031245

(51) Int. Cl. H04L 9/40; H04L 65/1066; H04L 67/104

(52) U.S. Cl. CPC H04L 63/065; H04L 65/1066; H04L 67/1044

(57) ABSTRACT

An electronic device is provided. The electronic device includes a communication circuit, memory, comprising one or more storage media, storing instructions, and at least one processor operatively connected to the communication circuit and the memory, wherein the instructions, when executed by the at least one processor individually or collectively, cause the electronic device to obtain, via the communication circuit from a server, encryption information related to a group including the electronic device, when an unencrypted packet is received from an external electronic device included in the group, check whether the group provides encrypted communication, when the group provides encrypted communication, transmit, to the external electronic device, a request signal related to updating the encryption information, and when a signal related to the completion of update of the encryption information is received from the external electronic device, receive the encrypted packet from the external electronic device.

### CROSS-REFERENCE TO RELATED APPLICATION(S)

This application is a continuation application, claiming priority under 35 U.S.C. § 365(c), of an International application No. PCT/KR2024/095058, filed on Jan. 26, 2024, which is based on and claims the benefit of a Korean patent application number 10-2023-0015925, filed on Feb. 7, 2023, in the Korean Intellectual Property Office, and of a Korean patent application number 10-2023-0031245, filed on Mar. 9, 2023, in the Korean Intellectual Property Office, the disclosure of each of which is incorporated by reference herein in its entirety.

### BACKGROUND

### 1. Field

The disclosure relates to an electronic device for wireless communication and an operational method thereof.

### 2. Description of Related Art

A mission critical function is a communication technology that supports group communication based on a mobile communication network such as a long term evolution (LTE) communication technology. The mission critical function may include a mission critical push to talk (MCPTT) function, a mission critical data (MCData) function, and/or a mission critical video (MCVideo) function.

The above information is presented as background information only to assist with an understanding of the disclosure. No determination has been made, and no assertion is made, as to whether any of the above might be applicable as prior art with regard to the disclosure.

### SUMMARY

Mission critical functions may be used to provide media services such as calls, message transmission, and/or file transfer related to emergency situations such as disasters, traffic accidents, and/or fires. When a wireless communication system provides the mission critical functions, the wireless communication system is relatively sensitive to communication security based on work characteristics related to emergency situations, and may manage encryption and grouping of signals and/or data for wireless communication through a separate server (e.g., common service core (CSC)) for group calls of a plurality of electronic devices. For example, the CSC may include a group management server (GMS), a configuration management server (CMS), an identity management server (IDMS), and/or a key management server (KMS).

When the electronic device provides the mission critical functions, the electronic device may perform encrypted communication (or secure communication) with an external electronic device based on encryption information obtained from a separate server (e.g., GMS and/or KMS). When the electronic device does not obtain encryption information due to the influence of a communication status (e.g., timing) and/or a wireless environment, or obtains incorrect encryption information, the electronic device may have limited communication with an external electronic device. For example, the electronic device may not decrypt (or restore) encrypted data received from the external electronic device, and therefore, may not check and reproduce data transmitted by the external electronic device. For example, the electronic device may have a limited control operation of speaking rights related to a group call.

Aspects of the disclosure are to address at least the above-mentioned problems and/or disadvantages and to provide at least the advantages described below. Accordingly, an aspect of the disclosure is to provide an apparatus and method for providing wireless communication related to the mission critical functions (e.g., MCPTT, MCVideo, and/or MCData) in the electronic device.

Additional aspects will be set forth in part in the description which follows and, in part, will be apparent from the description, or may be learned by practice of the presented embodiments.

In accordance with an aspect of the disclosure, an electronic device is provided. The electronic device includes a communication circuit, memory, comprising one or more storage media, storing instructions, and at least one processor operatively connected to the communication circuit and the memory, wherein the instructions, when executed by the at least one processor individually or collectively, cause the electronic device to obtain, from a server, encryption information related to a group including the electronic device, when an unencrypted packet is received from an external electronic device included in the group, check whether the group provides encrypted communication, when the group provides the encrypted communication, transmit, to the external electronic device, a request signal related to updating the encryption information, when a signal related to a completion of updating the encryption information is received from the external electronic device, receive an encrypted packet from the external electronic device.

In accordance with another aspect of the disclosure, a method performed by an electronic device is provided. The method includes obtaining, from a server, encryption information related to a group including the electronic device, when an unencrypted packet is received from an external electronic device included in the group, checking whether a group provides encrypted communication, when the group provides the encrypted communication, transmitting, to the external electronic device, a request signal related to updating the encryption information, when a signal related to a completion of updating the encryption information is received from the external electronic device, receiving an encrypted packet from the external electronic device.

In accordance with another aspect of the disclosure, one or more non-transitory computer-readable storage media storing one or more programs including computer-executable instructions that, when executed by one or more processors of an electronic device individually or collectively, cause the electronic device to perform operations are provided. the operations include obtaining, from a server, encryption information related to a group including the electronic device, when an unencrypted packet is received from an external electronic device included in the group, checking whether the group provides encrypted communication, when the group provides the encrypted communication, transmitting a request signal related to updating the encryption information, and when a signal related to a completion of updating the encryption information is received from the external electronic device, receiving an encrypted packet from the external electronic device.

According to one embodiment of the disclosure, when it is determined that the encryption information does not match the external electronic device performing communication based on the mission critical function in the electronic device, the encrypted communication is performed by updating the encryption information of the electronic device, or by controlling the update of the encryption information of the external electronic device.

According to one embodiment, when it is determined that the encryption information does not match the external electronic device performing communication based on the mission critical function in the electronic device, the communication connection is performed without encryption based on the user's selection, thereby smoothly providing the wireless communication in the emergency situation.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of an electronic device for wireless communication according to an embodiment of the disclosure;

FIG. 3 is a flowchart for controlling an update of encryption information of an external electronic device by the electronic device according to an embodiment of the disclosure;

FIG. 4 is a flowchart for transmitting an encryption information update request signal in the electronic device according to an embodiment of the disclosure;

FIG. 5 is a flowchart for performing unencrypted communication in the electronic device according to an embodiment of the disclosure;

FIG. 6 is a flowchart for performing the unencrypted communication in the electronic device according to an embodiment of the disclosure;

FIG. 7 is a flowchart for updating encryption information in the external electronic device according to an embodiment of the disclosure;

FIG. 8 is an example in which the electronic device performs encrypted communication with the external electronic device according to an embodiment of the disclosure;

FIG. 9 is an example in which the electronic device performs unencrypted communication with the external electronic device according to an embodiment of the disclosure;

FIG. 10 is an example for updating the encryption information in the external electronic device according to an embodiment of the disclosure;

FIG. 11 is a flowchart for updating the encryption information in the electronic device according to an embodiment of the disclosure;

FIG. 12 is a flowchart for updating the encryption information in the external electronic device according to an embodiment of the disclosure;

FIG. 13 is a flowchart for updating the encryption information in the electronic device according to an embodiment of the disclosure;

FIG. 14 is an example in which the electronic device performs the encrypted communication with the external electronic device according to an embodiment of the disclosure; and

FIG. 15 is an example for updating the encryption information in the electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

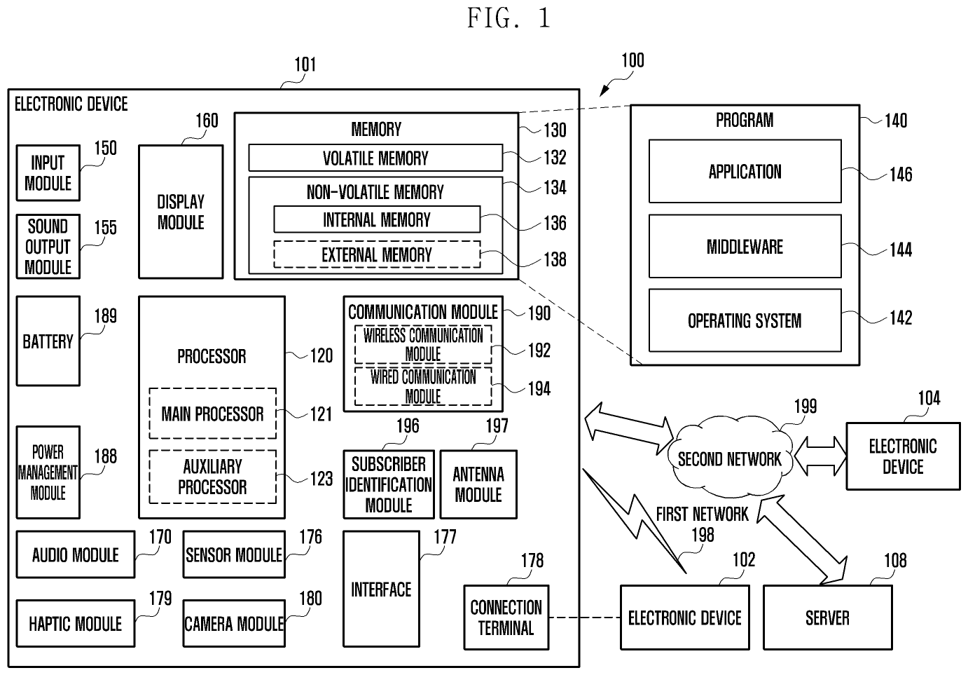

FIG. 1 is a block diagram illustrating an example electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC. According to one embodiment, the subscriber identification module 196 may include a plurality of subscriber identification modules. For example, the plurality of subscriber identification modules may store different subscriber information.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band. For example, the plurality of antennas may include patch array antennas and/or dipole array antennas.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

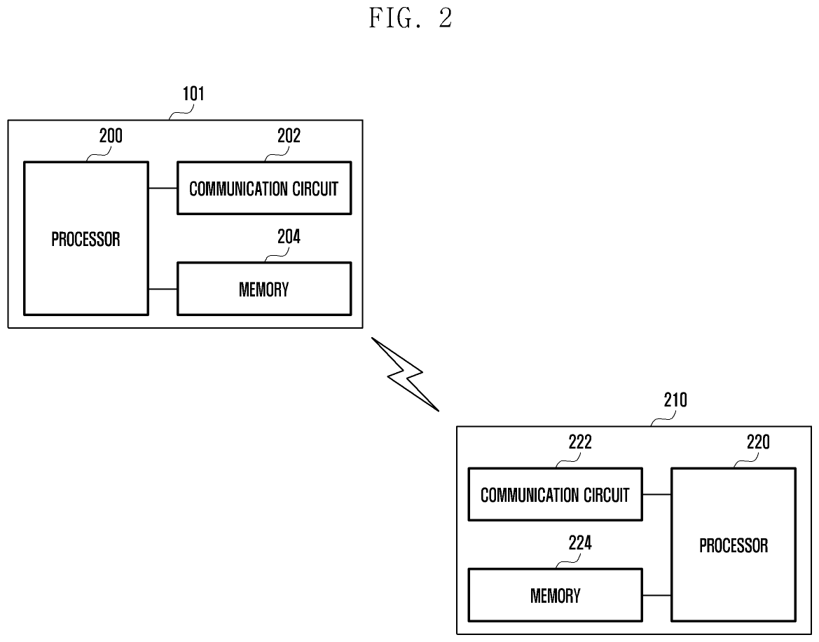

FIG. 2 is a block diagram of an electronic device for wireless communication according to an embodiment of the disclosure.

For example, the electronic device 101 of FIG. 2 may be at least partially similar to the electronic device 101 of FIG. 1, or may include other embodiments of the electronic device. For example, the external electronic device 210 of FIG. 2 may be at least partially similar to the electronic device 101 of FIG. 1, or may include other embodiments of the electronic device.

Referring to FIG. 2, the electronic device 101 may include a processor 200 (including processing circuitry), a communication circuit (or communication circuitry) 202, and/or memory 204. According to one embodiment, the processor 200 may be substantially the same as the processor 120 of FIG. 1, or may be included in the processor 120. The communication circuit 202 may be substantially the same as the wireless communication module 192 of FIG. 1, or may be included in the wireless communication module 192. The memory 204 may be substantially the same as the memory 130 of FIG. 1, or may be included in the memory 130. According to one embodiment, the processor 200 may be operatively, functionally, and/or electrically connected to the communication circuit 202 and/or the memory 204.

According to one embodiment, the processor 200 may obtain encryption information related to group communication (or group call). According to one embodiment, the processor 200 may obtain (or receive) identification information related to a group to which the electronic device 101 is subscribed from a configuration management server (CMS). For example, the identification information related to the group may include uniform resource identifier (URI) information of the group. For example, the CMS may represent the electronic device 101 and/or a server that manages capability and/or authority related to a user of the electronic device 101. For example, the encryption information is information required to derive a key for encrypting and/or decrypting a packet (or data) transmitted and/or received during the group communication (or the group call), and may include, but is not limited to, a traffic generating key (TGK) (e.g., a group master key (GMK)), a random value (RAND), a crypto session bundle identifier (CSB-ID), and/or a crypto session identifier (CS-ID). For example, the key for encrypting and/or decrypting the packet (or data) may include a security real-time transport protocol (SRTP) session key. For example, the derivation of the key for encrypting and/or decrypting the packet (or data) may include a series of operations of generating an SRTP master key and/or an SRTP master salt based on information (e.g., TGK, RAND, CSB-ID, and/or CS-ID) required to derive the key for encrypting and/or decrypting the packet (or data), and generating the SRTP session key based on the SRTP master key and/or the SRTP master salt.

According to one embodiment, the processor 200 may obtain configuration information related to the group to which the electronic device 101 is subscribed from a group management server (GMS) based on the identification information related to the group to which the electronic device 101 is subscribed obtained from the CMS. For example, the configuration information related to the group may include at least one of information (e.g., SRTP enable information) related to whether the group supports encrypted communication, information related to an external electronic device 210 included in the group, and/or a communication type (e.g., a call type) of the group. For example, the GMS may represent a server that manages group information.

According to one embodiment, the processor 200 may obtain information related to, for example, a root certificate and/or an encryption key (or a user key) from a key management server (KMS). For example, the encryption key may include a KMS key, which is a pre-routing key that the electronic device 101 obtains from the KMS. For example, the KMS may represent a server that manages the encryption key.

According to one embodiment, the processor 200 may obtain the encryption information for the encrypted communication with at least one external electronic device 210 included in the group based on the configuration information related to the group to which the electronic device 101 is subscribed and information related to the encryption key. For example, when the processor 200 determines that the group to which the electronic device 101 is subscribed supports the encrypted communication, the processor 200 may control the communication circuit 202 to transmit a request signal (e.g., SUBSCRIBE) related to the encryption information to the GMS through a mission critical push to anything (MCPTX)/media server. The processor 200 may receive a response signal corresponding to the request signal related to the encryption information from the GMS through the MCPTX/media server. The processor 200 may decrypt the response signal based on the encryption key obtained from the KMS to obtain (or receive) the encryption information for the encrypted communication with at least one external electronic device 210 included in the group to which the electronic device 101 is subscribed. For example, the MCPTX/media server is a server that supports mission critical functions, and includes a media server that processes voice data and an MCPTX server that transfers the encryption information related to the group call. For example, the response signal is a message (e.g., MIKEY message) encrypted with the encryption key (e.g., the KMS key), and may include GMK GKTP.

According to one embodiment, when the processor 200 fails to decrypt the response signal based on the encryption key obtained from the KMS, it may be determined that the processor 200 may not provide the encrypted communication with at least one external electronic device 210 included in the group to which the electronic device 101 is subscribed.

According to one embodiment, the processor 200 may control the communication circuit 202 to transmit information related to updating the encryption information of the external electronic device 210 included in the group to which the electronic device 101 is subscribed. According to one embodiment, when the processor 200 obtains the encryption information related to the group call, the processor 200 may check whether a packet received from the external electronic device 210 included in the group to which the electronic device 101 is subscribed is an encrypted packet (e.g., SRTP). For example, when a master key identifier (MKI) exists in a packet received from the external electronic device 210, the processor 200 may determine that the packet received from the external electronic device 210 is the encrypted packet. For example, when an MKI does not exist in the packet received from the external electronic device 210, the processor 200 may determine that the packet received from the external electronic device 210 is an unencrypted packet (e.g., real-time transport protocol (RTP)).

According to one embodiment, when the processor 200 receives the unencrypted packet from the external electronic device 210 while obtaining the encryption information related to the group call, the processor 200 may determine that the encryption information of the external electronic device 210 needs to be updated. The processor 200 may control the communication circuit 202 to transmit a request signal related to updating the encryption information to the external electronic device 210 based on the determination that the encryption information of the external electronic device 210 needs to be updated. For example, the processor 200 may check whether the group to which the electronic device 101 is subscribed supports the encrypted communication through the GMS based on the determination that the encryption information of the external electronic device 210 needs to be updated. For example, when the processor 200 determines that the group to which the electronic device 101 is subscribed supports the encrypted communication, the processor 200 may control the communication circuit 202 to transmit the request signal related to updating the encryption information to the external electronic device 210. For example, when the processor 200 determines that the group to which the electronic device 101 is subscribed supports the encrypted communication, the processor 200 may update the encryption key and/or the encryption information.

According to one embodiment, when the processor 200 receives a signal related to the completion of updating the encryption information from the external electronic device 210 through the communication circuit 202, the processor 200 may control the communication circuit 202 to perform the encrypted communication with the external electronic device 210. According to one embodiment, when the processor 200 receives the encrypted packet from the external electronic device 210, the processor 200 may decrypt the encrypted packet based on the encryption information of the group to which the electronic device 101 is subscribed. The processor 200 may control an output device (not illustrated) of the electronic device 101 to output the decrypted data to the outside. For example, the output device of the electronic device 101 may include a speaker and/or a display.

According to one embodiment, when the processor 200 receives a signal related to a failure to update the encryption information from the external electronic device 210 through the communication circuit 202, the processor 200 may control the communication circuit 202 to perform the unencrypted communication. According to one embodiment, when the processor 200 receives the signal related to the failure to update the encryption information from the external electronic device 210 through the communication circuit 202, the processor 200 may control the external electronic device 210 to update the encryption information for a designated number of times. For example, a configuration for controlling the external electronic device 210 to update the encryption information may include a series of operations of transmitting the request signal related to updating the encryption information to the external electronic device 210.

According to one embodiment, when it is determined that the processor 200 fails to update the encryption information of the external electronic device 210 for the designated number of times, the processor 200 may determine whether to provide the unencrypted communication. For example, the processor 200 may control the output device of the electronic device 101 to output information related to receiving the unencrypted packet. When the processor 200 detects an input related to performance of the unencrypted communication in response to the information related to receiving the unencrypted packet, it may be determined that the processor 200 provides the unencrypted communication. When the processor 200 does not detect the input related to the performance of the unencrypted communication in response to the information related to receiving the unencrypted packet, or detects an input related to non-performance of the unencrypted communication, the processor 200 may terminate the group communication (or the group call). For example, the processor 200 may check whether a menu (or an unencrypted menu) related to receiving the unencrypted packet is configured. When the menu related to receiving the unencrypted packet is configured to an enable state, it may be determined that the processor 200 provides the unencrypted communication. The processor 200 may terminate the group communication (or the group call) when the menu related to receiving the unencrypted packet is configured to a disable state.

According to one embodiment, the processor 200 may update the encryption information of the electronic device 101. According to one embodiment, when the processor 200 does not obtain the encryption information related to the group call, the processor 200 may check whether the packet received from the external electronic device 210 included in the group to which the electronic device 101 is subscribed is the encrypted packet (e.g., SRTP). For example, when the MKI exists in the packet received from the external electronic device 210, the processor 200 may determine that the packet received from the external electronic device 210 is the encrypted packet. For example, when the MKI does not exist in the packet received from the external electronic device 210, the processor 200 may determine that the packet received from the external electronic device 210 is the unencrypted packet (e.g., RTP).

According to one embodiment, when the processor 200 receives the encrypted packet from the external electronic device 210 without obtaining the encryption information related to the group call, the processor 200 may determine that the encryption information of the electronic device 101 needs to be updated. Based on the determination that the encryption information of the electronic device 101 needs to be updated, the processor 200 may check whether the group to which the electronic device 101 is subscribed supports the encrypted communication through the GMS. For example, when the processor 200 determines that the group to which the electronic device 101 is subscribed supports the encrypted communication, the processor 200 may update the encryption key and/or the encryption information.

According to one embodiment, when the processor 200 receives the unencrypted packet from the external electronic device 210 without obtaining the encryption information related to the group call, the processor 200 may control the output device (not illustrated) of the electronic device 101 to output data included in the packet received from the external electronic device 210 to the outside. For example, the output device of the electronic device 101 may include the speaker and/or the display.

According to one embodiment, when the processor 200 receives a signal (e.g., INVITE) related to communication configuration including the encryption information (e.g., a PCK message) from the external electronic device 210, the processor 200 may decrypt the encryption information included in the signal related to the communication configuration based on the encryption key obtained from the KMS. According to one embodiment, when the processor 200 fails to decrypt encryption information, the processor 200 may update the encryption key through the KMS. The processor 200 may control the communication circuit 202 to transmit the request signal related to updating the encryption information to the external electronic device 210. When the processor 200 receives an update signal including the encryption information from the external electronic device 210 in response to the request signal related to updating the encryption information, the processor 200 may decrypt the encryption information included in the update signal based on the updated encryption key.

According to one embodiment, when the processor 200 succeeds in decrypting the encryption information, the processor 200 may perform a session connection related to individual communication (or individual call) with the external electronic device 210. For example, when the processor 200 succeeds in decrypting the encryption information, the processor 200 may control the communication circuit 202 to transmit information related to the completion of the communication establishment to the external electronic device 210. For example, the processor 200 may decrypt the encrypted packet received from the external electronic device 210 based on the encryption information. For example, the processor 200 may control the communication circuit 202 to transmit the encrypted packet to the external electronic device 210 based on the encryption information.

According to one embodiment, when the processor 200 has consecutively failed to decrypt the encryption information for the designated number of times, the processor 200 may terminate the communication (e.g., individual call) with the external electronic device 210.

According to one embodiment, the communication circuit 202 may cause the electronic device 101 to transmit and/or receive signals and/or data to and from at least one external electronic device 210 (e.g., the electronic device 102 or 104 of FIG. 1 or the server 108). According to one embodiment, the communication circuit 202 may include a radio frequency integrated circuit (RFIC) and/or a radio frequency front end (RFFE) for communicating with at least one external electronic device 210.

According to one embodiment, the memory 204 may store various data used by at least one component (e.g., the processor 200 and/or the communication circuit 202) of the electronic device 101. For example, the data may include information related to the encryption information and/or the encryption key. According to one embodiment, the memory 204 may store various instructions that may be executed by the processor 200.

According to one embodiment, the external electronic device 210 may include a processor 220 (including processing circuitry), a communication circuit (or communication circuitry) 222, and/or memory 224. According to one embodiment, the processor 220 may be substantially the same as the processor 120 of FIG. 1, or may be included in the processor 120. The communication circuit 222 may be substantially the same as the wireless communication module 192 of FIG. 1, or may be included in the wireless communication module 192. The memory 224 may be substantially the same as the memory 130 of FIG. 1, or may be included in the memory 130. According to one embodiment, the processor 220 may be operatively, functionally, and/or electrically connected to the communication circuit 222 and/or the memory 224.

According to one embodiment, the processor 220 may obtain the encryption information related to the group communication (or the group call). According to one embodiment, the processor 220 may obtain (or receive) the identification information related to the group to which the external electronic device 210 is subscribed from the CMS. For example, the encryption information is information required to derive the key for encrypting and/or decrypting the packet (or data) transmitted and/or received during the group communication (or the group call), and may include, but is not limited to, the TGK (e.g., the GMK), the RAND, the CSB-ID, and/or the CS-ID. For example, the key for encrypting and/or decrypting the packet (or data) may include the SRTP session key. According to one embodiment, the processor 220 may obtain configuration information related to a group to which the external electronic device 210 is subscribed from the GMS based on identification information related to a group to which the external electronic device 210 is subscribed obtained from the CMS. According to one embodiment, the processor 220 may obtain the information related to the root certificate and/or the encryption key (or the user key) from the KMS.

According to one embodiment, the processor 220 may obtain the encryption information for the encrypted communication with at least one electronic device 101 included in the group and/or another external electronic device based on the configuration information related to the group to which the external electronic device 210 is subscribed and the information related to the encryption key. For example, when the processor 220 determines that the group to which the external electronic device 210 is subscribed supports the encrypted communication, the processor 220 may control the communication circuit 222 to transmit the request signal (e.g., SUBSCRIBE) related to the encryption information to the GMS through the MCPTX/media server. The processor 220 may receive the response signal corresponding to the request signal related to the encryption information from the GMS through the MCPTX/media server. The processor 220 may decrypt the response signal based on the encryption key obtained from the KMS to obtain the encryption information for the encrypted communication with at least one electronic device 101 included in the group to which the external electronic device 210 is subscribed and/or another external electronic device. For example, the response signal is a message (e.g., MIKEY message) encrypted with the encryption key (e.g., the KMS key), and may include GMK GKTP.

According to one embodiment, when the processor 220 fails to decrypt the response signal based on the encryption key obtained from the KMS, it may be determined that the processor 220 may not provide the encrypted communication with at least one electronic device 101 included in the group to which the external electronic device 210 is subscribed and/or another external electronic device.

According to one embodiment, when the processor 220 obtains the encryption information related to the group call, the processor 220 may control the communication circuit 222 to transmit the encrypted packet (e.g., SRTP) to the electronic device 101 based on the encryption information.

According to one embodiment, when the processor 220 does not obtain the encryption information related to the group call, the processor 220 may control the communication circuit 222 to transmit the unencrypted packet (e.g., RTP) to the electronic device 101.

According to one embodiment, when the processor 220 receives the request signal related to updating the encryption information from the electronic device 101, the processor 220 may update the encryption key and/or the encryption information through the KMS and/or the GMS. According to one embodiment, the processor 220 may check whether the group to which the external electronic device 210 is subscribed supports the encrypted communication through the GMS based on the request signal related to updating the encryption information received from the electronic device 101. According to one embodiment, when the processor 220 determines that the group to which the external electronic device 210 is subscribed supports the encrypted communication, the processor 220 may update the encryption key (or the user key) through the KMS.

According to one embodiment, the processor 220 may obtain the encryption information for the encrypted communication with at least one electronic device 101 included in the group and/or another external electronic device based on the information related to the encryption key updated through the KMS. For example, the processor 220 may control the communication circuit 222 to transmit the update signal (e.g., SUBSCRIBE) related to the encryption information to the GMS through the MCPTX/media server. The processor 220 may receive the response signal corresponding to the update signal related to the encryption information from the GMS through the MCPTX/media server. The processor 220 may decrypt the response signal based on the encryption key updated through the KMS.

According to one embodiment, when the processor 220 succeeds in decrypting the response signal, the processor 220 may control the communication circuit 222 to transmit the signal related to the completion of updating the encryption information to the electronic device 101. The processor 220 may control the communication circuit 222 to transmit the encrypted packet to the electronic device 101 based on the encryption information.

According to one embodiment, when the processor 220 fails to decrypt the response signal, the processor 220 may control the communication circuit 222 to transmit the signal related to the failure to update the encryption information to the electronic device 101.

According to one embodiment, the processor 220 may control the communication circuit 222 to transmit the signal related to the communication configuration (e.g., INVITE) including the encryption information (e.g., a PCK message) for individual communication (or private call) with the electronic device 101 to the electronic device 101. For example, the encryption information may be encrypted based on the encryption information of the group to which the external electronic device 210 is subscribed.

According to one embodiment, when the processor 220 receives information (e.g., 200 OK) related to the completion of the communication establishment from the electronic device 101, the processor 220 may perform the session connection related to the individual communication with the electronic device 101. The processor 220 may control the communication circuit 222 to transmit the encrypted packet to the electronic device 101 based on the encryption information. The processor 220 may decrypt the encrypted packet received from the electronic device 101 based on the encryption information.

According to one embodiment, when the processor 220 receives the request signal related to updating the encryption information from the electronic device 101, the processor 220 may update the encryption key and/or the encryption information through the KMS and/or the GMS. The processor 220 may control the communication circuit 222 to transmit the update signal including the encryption information to the electronic device 101 in response to the request signal related to updating the encryption information.

According to one embodiment, when the processor 220 receives the information (e.g., 200 OK) related to obtaining the encryption information from the electronic device 101 in response to the update signal, the processor 220 may perform the session connection related to the individual communication with the electronic device 101. The processor 220 may control the communication circuit 222 to transmit the encrypted packet to the electronic device 101 based on the encryption information. The processor 220 may decrypt the encrypted packet received from the electronic device 101 based on the encryption information.

According to one embodiment, when the processor 220 receives information (e.g., 488 not acceptable here) related to a failure to obtain the encryption information from the electronic device 101, the processor 220 may terminate the call with the electronic device 101.

According to one embodiment, the communication circuit 222 may cause the external electronic device 210 to transmit and/or receive signals and/or data with at least one electronic device 101 and/or at least one another external electronic device (e.g., the electronic device 102 or 104 of FIG. 1 or the server 108). According to one embodiment, the communication circuit 222 may include the RFIC and/or the RFFE for communicating with at least one electronic device 101.

According to one embodiment, the memory 224 may store various data used by at least one component (e.g., the processor 220 and/or the communication circuit 222) of the external electronic device 210. For example, the data may include the information related to the encryption information and/or the encryption key. According to one embodiment, the memory 224 may store various instructions that may be executed by the processor 220.

According to one embodiment, when the external electronic device 210 (or the processor 220) receives the request signal related to updating the encryption information from another external electronic device while receiving the request signal related to updating the encryption information related to the group to which the external electronic device 210 is subscribed from the electronic device 101, the external electronic device 210 may transmit the signal related to the failure to update the encryption information to another external electronic device. According to one embodiment, the external electronic device 210 may perform the update of the encryption information based on the request signal related to updating the encryption information received from the electronic device 101. When the external electronic device 210 is performing the update of the encryption information based on the request of the electronic device 101 or receives the request signal related to updating the encryption information from another external electronic device while updating the encryption information, the external electronic device 210 may transmit the signal related to the failure to update the encryption information to the another external electronic device in order to prevent the repetitive update of the encryption information.

According to one embodiment, the electronic device (e.g., the electronic device 101 of FIG. 1 or 2) may include the communication circuit (e.g., the wireless communication module 192 of FIG. 1 or the communication circuit 202 of FIG. 2), at least one processor (e.g., the processor 120 of FIG. 1 or the processor 200 of FIG. 2) operatively connected to the communication circuit and memory (e.g., the memory 130 of FIG. 1 or the memory 204 of FIG. 2) comprising one or more storage media, storing instructions. According to one embodiment, the instructions, when executed by the at least one processor individually or collectively, cause the electronic device to obtain, from the server, the encryption information related to the group including the electronic device. According to one embodiment, the instructions, when executed by the at least one processor individually or collectively, cause the electronic device to, when the unencrypted packet is received from the external electronic device included in the group, check whether the group provides the encrypted communication. According to one embodiment, the instructions, when executed by the at least one processor individually or collectively, cause the electronic device to, when the group provides the encrypted communication, transmit the request signal related to updating the encryption information to the external electronic device. According to one embodiment, the instructions, when executed by the at least one processor individually or collectively, cause the electronic device to, when the signal related to the completion of updating the encryption information is received from the external electronic device, receive the encrypted packet from the external electronic device.

According to one embodiment, the instructions, when executed by the at least one processor individually or collectively, cause the electronic device to determine that the packet received from the external electronic device is an unencrypted packet when the packet received from the external electronic device does not include the master key identifier (MKI). According to one embodiment, the instructions, when executed by the at least one processor individually or collectively, cause the electronic device to determine that the packet received from the external electronic device is an encrypted packet when the packet received from the external electronic device includes the MKI.

According to one embodiment, the instructions, when executed by the at least one processor individually or collectively, cause the electronic device to decrypt the encrypted packet from the external electronic device based on the encryption information when the encrypted packet is received from the external electronic device included in the group.

According to one embodiment, the instructions, when executed by the at least one processor individually or collectively, cause the electronic device to update the encryption key related to the group through the server when the at least one processor determines the group including the electronic device provides the encrypted communication. According to one embodiment, the instructions, when executed by the at least one processor individually or collectively, cause the electronic device to update the encryption information related to the group through the server.

According to one embodiment, the instructions, when executed by the at least one processor individually or collectively, cause the electronic device to decrypt the encrypted packet received from the external electronic device based on the updated encryption information.

According to one embodiment, the instructions, when executed by the at least one processor individually or collectively, cause the electronic device to output the information related to receiving the unencrypted packet to the outside when the at least one process receives the signal related to the failure to update the encryption information from the external electronic device. According to one embodiment, the instructions, when executed by the at least one processor individually or collectively, cause the electronic device to output the unencrypted packet received from the external electronic device to the outside when the input related to the performance of the unencrypted communication is detected based on the output information.

According to one embodiment, the instructions, when executed by the at least one processor individually or collectively, cause the electronic device to check whether the menu related to receiving the unencrypted packet is configured when the at least one processor receives the signal related to the failure to update the encryption information from the external electronic device. According to one embodiment, the instructions, when executed by the at least one processor individually or collectively, cause the electronic device to output the unencrypted packet received from the external electronic device to the outside when the menu related to receiving the unencrypted packet is configured.

According to one embodiment, the instructions, when executed by the at least one processor individually or collectively, cause the electronic device to decrypt the encryption information obtained from the grouping management server (GMS) based on the encryption key obtained from the key management server (KMS), thereby obtaining the encryption information related to the group including the electronic device.

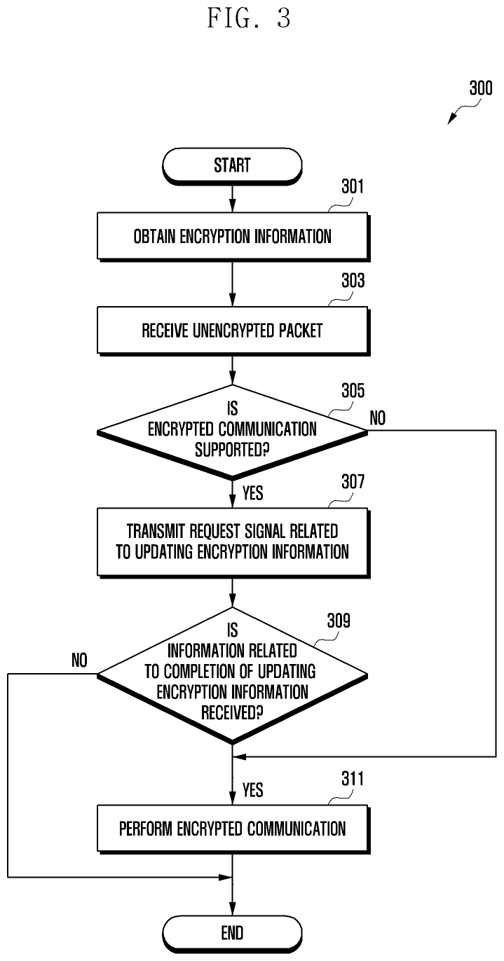

FIG. 3 is a flowchart (300) for controlling the update of the encryption information of the external electronic device by the electronic device according to an embodiment of the disclosure.

In the following embodiments, each operation may be performed sequentially, but is not necessarily performed sequentially. For example, the order of each operation may be changed, and at least two operations may also be performed in parallel. For example, an electronic device of FIG. 3 may be the electronic device 101 of FIG. 1 or 2.

Referring to FIG. 3, in operation 301, the electronic device (e.g., the processor 120 of FIG. 1 or the processor 200 of FIG. 2) may obtain (or receive) the encryption information related to the group communication (or the group call). According to one embodiment, the processor 200 may obtain (or receive) an account and/or a password related to a mission critical function based on the execution of an application program related to the mission critical function. For example, the mission critical function may include the mission critical push to talk (MCPTT) function, the mission critical data (MCData) function, and/or the mission critical video (MCVideo) function. For example, the account and/or the password related to the mission critical function may be obtained from a user input and/or a subscriber identity module (SIM) of the electronic device 101. According to one embodiment, the processor 200 may obtain information related to accessing (or registering with) the MCPTX/media server when the processor 200 is logged in to the MCPTX/media server based on the account and/or the password related to the mission critical function. For example, the MCPTX/media server is a server that supports the mission critical function, and includes a media server that processes voice data and an MCPTX server that transfers the encryption information related to the group call. According to one embodiment, the processor 200 may control the communication circuit 202 to access (or register with) the MCPTX/media server based on the information related to accessing (or registering with) the MCPTX/media server. For example, the access to (or registration with) the MCPTX/media server may include a series of operations in which the electronic device 101 establishes a communication link with the MCPTX/media server, which is a network entity, through a base station. According to one embodiment, the processor 200 may obtain the encryption information related to the group communication (or the group call) before, during, or after the access to the MCPTX/media server. For example, the processor 200 may obtain the identification information (e.g., uniform resource identifier (URI)) related to the group to which the electronic device 101 is subscribed from the configuration management server (CMS). For example, the encryption information is information required to derive the key (e.g., the security real-time transport protocol (SRTP) session key) for encrypting and/or decrypting the packet (or data) transmitted and/or received during the group communication (or the group call), and may include the traffic generating key (TGK) (e.g., the group master key (GMK)), the random value (RAND), the crypto session bundle identifier (CSB-ID), and/or the crypto session identifier (CS-ID). For example, the derivation of the key for encrypting and/or decrypting the packet (or data) may include a series of operations of generating the SRTP master key and/or the SRTP master salt based on information (e.g., TGK, RAND, CSB-ID, and/or CS-ID) required to derive the key for encrypting and/or decrypting the packet (or data), and generating the SRTP session key based on the SRTP master key and/or the SRTP master salt.

For example, the processor 200 may obtain the configuration information related to the group to which the electronic device 101 is subscribed from the group management server (GMS) based on the identification information related to the group to which the electronic device 101 is subscribed obtained from the CMS. For example, the processor 200 may obtain the information related to, for example, the root certificate and/or the encryption key (or the user key) (e.g., the KMS key) from the key management server (KMS).

For example, when the processor 200 determines that the group to which the electronic device 101 is subscribed supports the encrypted communication, the processor 200 may control the communication circuit 202 to transmit the request signal (e.g., SUBSCRIBE) related to the encryption information to the GMS through the MCPTX/media server. When the processor 200 receives the response signal corresponding to the request signal related to the encryption information from the GMS through the MCPTX/media server, the processor 200 may decrypt the response signal based on the encryption key obtained from the KMS to obtain the encryption information related to the group to which the electronic device 101 is subscribed. For example, the response signal is the message (e.g., the MIKEY message) encrypted with the encryption key (e.g., the KMS key), and may include the GMK GKTP.

According to one embodiment, the processor 200 may control the communication circuit 202 to transmit the information related to the group communication to the MCPTX/media server based on the occurrence of an event related to a start of the group communication (or the group call) while accessing (or registering with) the MCPTX/media server. According to one embodiment, when the processor 200 receives the response signal (e.g., 200 OK) corresponding to the information related to the group communication from the MCPTX/media server through the communication circuit 202, the processor 200 may determine, through the MCPTX/media server, that the group communication with at least one external electronic device 210 included in the group to which the electronic device 101 is subscribed is configured. For example, the configuration of the group communication may include a series of operations for establishing a group session for the group communication with at least one external electronic device 210 included in the group to which the electronic device 101 is subscribed.

According to one embodiment, in operation 303, the electronic device (e.g., the processor 120 or 200) may receive the unencrypted packet (e.g., RTP) from the external electronic device 210 included in the group. According to one embodiment, when the processor 200 decrypts the encrypted information received from the GMS based on the encryption key obtained from the KMS, it may be determined that the processor 200 may provide the encrypted communication. According to one embodiment, when the processor 200 receives the packet from the external electronic device 210 while determining that the processor 200 provides the encrypted communication, the processor 200 may check whether the corresponding packet is the encrypted packet (e.g., SRTP). For example, when the master key identifier (MKI) exists in the packet received from the external electronic device 210, the processor 200 may determine that the packet received from the external electronic device 210 is the encrypted packet. For example, when the MKI does not exist in the packet received from the external electronic device 210, the processor 200 may determine that the packet received from the external electronic device 210 is the unencrypted packet (e.g., the real-time transport protocol (RTP)).

According to one embodiment, in operation 305, the electronic device (e.g., the processor 120 or 200) may check whether the group to which the electronic device 101 is subscribed supports the encrypted communication based on the reception of the unencrypted packet (e.g., RTP) from the external electronic device 210 included in the group. According to one embodiment, when the processor 200 receives the unencrypted packet from the external electronic device 210 while obtaining the encryption information related to the group call, the processor 200 may determine that the encryption information of the external electronic device 210 needs to be updated. According to one embodiment, the processor 200 may check whether the group to which the electronic device 101 is subscribed supports the encrypted communication through the GMS based on the determination that the encryption information of the external electronic device 210 needs to be updated.

According to one embodiment, when the electronic device (e.g., the processor 120 or 200) determines that the group to which the electronic device 101 is subscribed does not support the encrypted communication (e.g., ‘No’ in operation 305), the electronic device may terminate one embodiment for controlling the encryption information of the external electronic device 210 to be updated. According to one embodiment, when the processor 200 determines that the group to which the electronic device 101 is subscribed does not support the encrypted communication, the processor 200 may control the output device (not illustrated) of the electronic device 101 to output the data included in the unencrypted packet received from the external electronic device 210 to the outside. For example, the output device of the electronic device 101 may include the speaker and/or the display.

According to one embodiment, when it is determined that the group to which the electronic device 101 is subscribed supports the encrypted communication (e.g., ‘yes’ in operation 305), in operation 307, the electronic device (e.g., the processor 120 or 200) may transmit the request signal related to updating the encryption information to the external electronic device 210. According to one embodiment, when the processor 200 determines that the group to which the electronic device 101 is subscribed supports the encrypted communication, the processor 200 may control the communication circuit 202 to transmit the request signal related to updating the encryption information to the external electronic device 210. According to one embodiment, when the processor 200 determines that the group to which the electronic device 101 is subscribed supports the encrypted communication, the processor 200 may update the encryption key and/or the encryption information of the electronic device 101.

According to one embodiment, in operation 309, the electronic device (e.g., processor 120 or 200) may check whether the signal related to the completion of updating the encryption information is received from the external electronic device 210 in response to the request signal related to updating the encryption information.

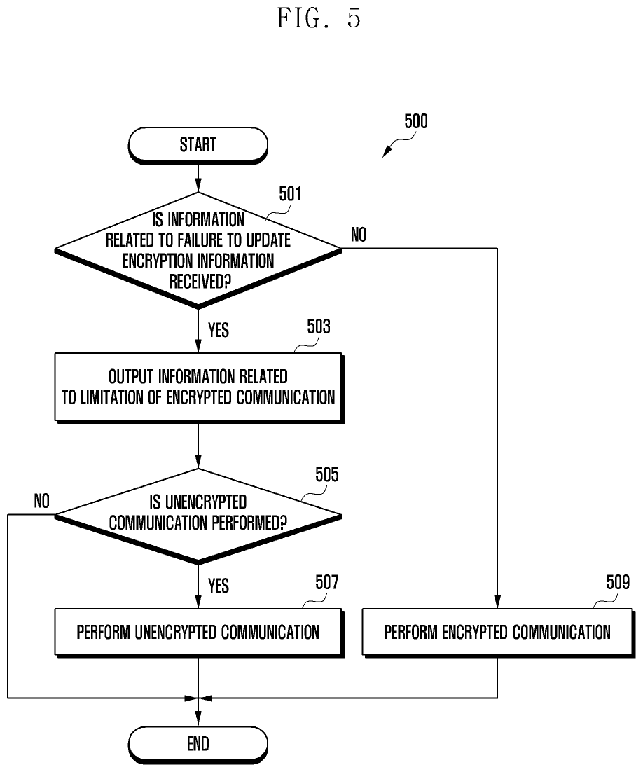

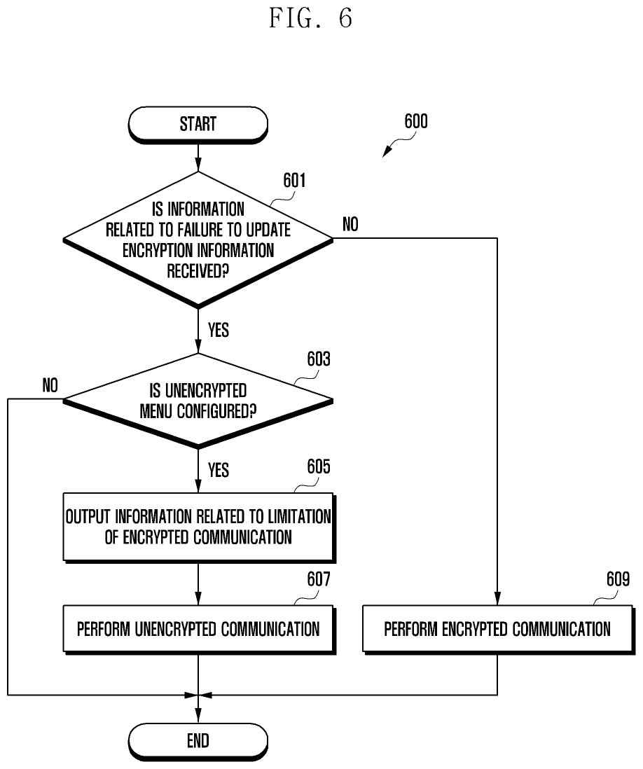

According to one embodiment, when the electronic device (e.g., the processor 120 or 200) receives the signal related to the failure to update the encryption information from the external electronic device 210 (e.g., ‘NO’ in operation 309), the electronic device may terminate one embodiment for controlling the encryption information of the external electronic device 210 to be updated. According to one embodiment, when the processor 200 receives the signal related to the failure to update the encryption information from the external electronic device 210 through the communication circuit 202, the processor 200 may control the external electronic device 210 to update the encryption information for the designated number of times. For example, the configuration for controlling the external electronic device 210 to update the encryption information may include a series of operations of transmitting the request signal related to updating the encryption information to the external electronic device 210. According to one embodiment, when it is determined that the processor 200 fails to update the encryption information of the external electronic device 210 for the designated number of times, the processor 200 may control the communication circuit 202 to provide the unencrypted communication, as illustrated in FIG. 5 or 6.

According to one embodiment, when the electronic device (e.g., the processor 120 or 200) receives the signal related to the completion of updating the encryption information from the external electronic device 210 (e.g., ‘Yes’ in operation 309), in operation 311, the electronic device may perform the encrypted communication with the external electronic device 210 included in the group. According to one embodiment, when the processor 200 receives the encrypted packet from the external electronic device 210, the processor 200 may decrypt the encrypted packet based on the encryption information of the group to which the electronic device 101 is subscribed. The processor 200 may control the output device (not illustrated) of the electronic device 101 to output the decrypted data to the outside. For example, the output device of the electronic device 101 may include the speaker and/or the display.

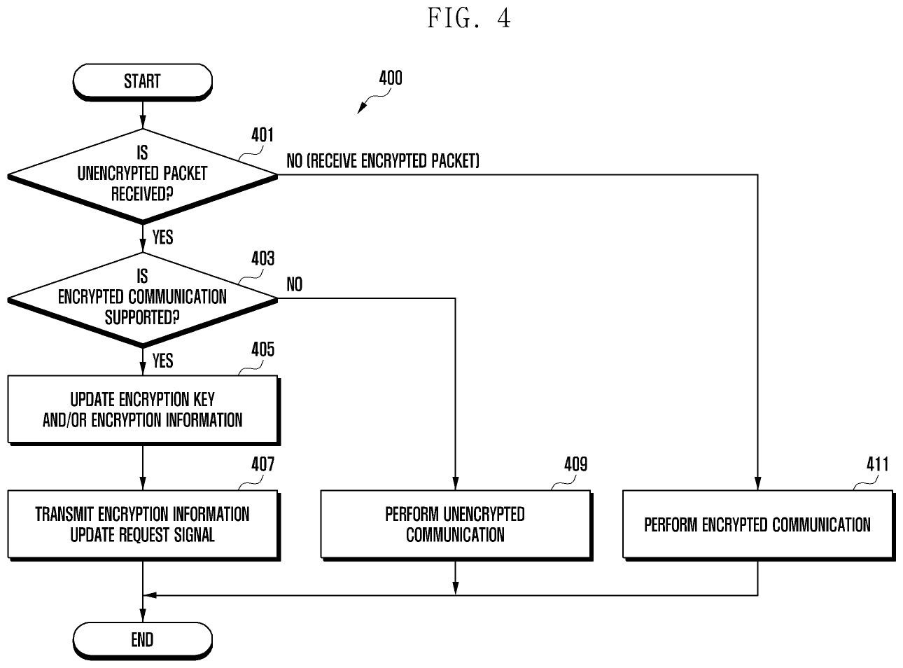

FIG. 4 is a flowchart (400) for transmitting an encryption information update request signal in the electronic device according to an embodiment of the disclosure.

According to one embodiment, at least a portion of FIG. 4 may include detailed operations of operations 303 to 307 of FIG. 3. In the following embodiments, each operation may be performed sequentially, but is not necessarily performed sequentially. For example, the order of each operation may be changed, and at least two operations may also be performed in parallel. For example, an electronic device of FIG. 4 may be the electronic device 101 of FIG. 1 or 2.

Referring to FIG. 4, when the electronic device (e.g., the processor 120 of FIG. 1 or the processor 200 of FIG. 2) obtains the encryption information related to the group communication (or the group call) (e.g., operation 301 of FIG. 3), in operation 401, the electronic device may check whether the unencrypted packet (e.g., RTP) is received from the external electronic device 210 included in the group. For example, when the master key identifier (MKI) exists in the packet received from the external electronic device 210, the processor 200 may determine that the packet received from the external electronic device 210 is the encrypted packet. For example, when the MKI does not exist in the packet received from the external electronic device 210, the processor 200 may determine that the packet received from the external electronic device 210 is the unencrypted packet (e.g., RTP).

According to one embodiment, when the electronic device (e.g., the processor 120 or 200) receives the unencrypted packet (e.g., RTP) from the external electronic device 210 included in the group (e.g., ‘Yes’ in 401), in operation 403, the electronic device may check whether the group to which the electronic device 101 is subscribed supports the encrypted communication. According to one embodiment, when the processor 200 receives the unencrypted packet (e.g., RTP) from the external electronic device 210 while obtaining the encryption information related to the group call, the processor 200 may determine that the encryption information of the external electronic device 210 needs to be updated. According to one embodiment, the processor 200 may obtain the configuration information related to the group to which the electronic device 101 is subscribed from the GMS based on the determination that the encryption information of the external electronic device 210 needs to be updated. According to one embodiment, when the configuration information related to the group obtained from the GMS includes SRTP enable information, the processor 200 may determine that the group to which the electronic device 101 is subscribed supports the encrypted communication. According to one embodiment, when the configuration information related to the group obtained from the GMS includes SRTP disable information, the processor 200 may determine that the group to which the electronic device 101 is subscribed does not support the encrypted communication.

According to one embodiment, when the electronic device (e.g., the processor 120 or 200) determines that the group to which the electronic device 101 is subscribed supports the encrypted communication (e.g., ‘Yes’ in operation 403), in operation 405, the electronic device (e.g., the processor 120 or 200) may update the encryption key and/or the encryption information of the electronic device 101. According to one embodiment, the processor 200 may obtain (or receive) the information related to, for example, the root certificate and/or the encryption key (or the user key) (e.g., the KMS key) from the KMS. According to one embodiment, the processor 200 may control the communication circuit 202 to transmit the request signal (e.g., SUBSCRIBE) related to the encryption information to the GMS through the MCPTX/media server. When the processor 200 receives the response signal corresponding to the request signal related to the encryption information from the GMS through the MCPTX/media server, the processor 200 may decrypt the response signal based on the encryption key obtained from the KMS to obtain the encryption information related to the group to which the electronic device 101 is subscribed. For example, the response signal is the message (e.g., the MIKEY message) encrypted with the encryption key (e.g., the KMS key), and may include the GMK GKTP.

According to one embodiment, in operation 407, the electronic device (e.g., the processor 120 or 200) may transmit the request signal related to updating the encryption information to the external electronic device. For example, the request signal related to updating the encryption information may include the update signal (e.g., UPDATE) with a P-Refresh-Security header set as required.

According to one embodiment, when the electronic device (e.g., the processor 120 or 200) determines that the group to which the electronic device 101 is subscribed does not support the encrypted communication (e.g., ‘NO’ in operation 403), in operation 409, the electronic device may perform the unencrypted communication. According to one embodiment, the processor 200 may control the output device (not illustrated) of the electronic device 101 to output the data included in the unencrypted packet received from the external electronic device 210 to the outside. For example, the output device of the electronic device 101 may include the speaker and/or the display.

According to one embodiment, when the electronic device (e.g., the processor 120 or 200) receives the encrypted packet (e.g., SRTP) from the external electronic device 210 included in the group (e.g., ‘No’ in operation 401), in operation 411, the electronic device may perform the encrypted communication with the external electronic device 210 included in the group. According to one embodiment, the processor 200 may decrypt the encrypted packet received from the external electronic device 210 based on the encryption information of the group to which the electronic device 101 is subscribed. The processor 200 may control the output device (not illustrated) of the electronic device 101 to output the decrypted data to the outside. For example, the output device of the electronic device 101 may include the speaker and/or the display.

FIG. 5 is a flowchart (500) for performing the unencrypted communication in the electronic device according to an embodiment of the disclosure.

According to one embodiment, at least a portion of FIG. 5 may include detailed operations of operations 309 and 311 of FIG. 3. In the following embodiments, each operation may be performed sequentially, but is not necessarily performed sequentially. For example, the order of each operation may be changed, and at least two operations may also be performed in parallel. For example, an electronic device of FIG. 5 may be the electronic device 101 of FIG. 1 or 2.

Referring to FIG. 5, when the electronic device (e.g., the processor 120 of FIG. 1 or the processor 200 of FIG. 2) transmits the request signal related to updating the encryption information to the external electronic device 210 (e.g., operation 307 of FIG. 3), in operation 501, the electronic device may check whether the signal related to the failure to update the encryption information is received in response to the request signal related to updating the encryption information.

According to one embodiment, when the electronic device (e.g., the processor 120 or 200) receives the signal related to the failure to update the encryption information in response to the request signal related to updating the encryption information (e.g., ‘Yes’ in operation 501), in operation 503, the electronic device may output the information related to receiving the unencrypted packet (e.g., RTP). According to one embodiment, when the processor 200 receives the signal related to the failure to update the encryption information from the external electronic device 210 through the communication circuit 202, the processor 200 may control the communication circuit 202 to transmit the request signal related to updating the encryption information to the external electronic device 210 for the designated number of times. According to one embodiment, when it is determined that the processor 200 has consecutively failed to update the encryption information of the external electronic device 210 for the designated number of times, the processor 200 may control the output device (not illustrated) of the electronic device 101 to output the information related to receiving the unencrypted packet. For example, the output device of the electronic device 101 may include the speaker and/or the display. For example, the information related to receiving the unencrypted packet may include information related to a state in which the unencrypted packet is received while the encrypted communication is configured.

According to one embodiment, in operation 505, the electronic device (e.g., the processor 120 or 200) may determine whether to provide the unencrypted communication. According to one embodiment, when the processor 200 detects an input related to performing the unencrypted communication in response to an output of the information related to receiving the unencrypted packet through the output device of the electronic device 101, it may be determined that the processor 200 provides the unencrypted communication. According to one embodiment, when the processor 200 does not detect the input related to performing the unencrypted communication or detects an input related to not performing the unencrypted communication in response to the output of the information related to receiving the unencrypted packet through the output device of the electronic device 101, it may be determined that the processor 200 does not provide the unencrypted communication.

According to one embodiment, when it is determined that the electronic device (e.g., the processor 120 or 200) does not provide the unencrypted communication (e.g., ‘No’ in operation 505), the electronic device may terminate the group communication (or the group call).

According to one embodiment, when it is determined that the electronic device (e.g., the processor 120 or 200) provides the unencrypted communication (e.g., ‘Yes’ in operation 505), in operation 507, the electronic device may perform the unencrypted communication. According to one embodiment, the processor 200 may control the output device (not illustrated) of the electronic device 101 to output the data included in the unencrypted packet received from the external electronic device 210 to the outside. For example, the output device of the electronic device 101 may include the speaker and/or the display.

According to one embodiment, when the electronic device (e.g., the processor 120 or 200) receives the signal related to the completion of updating the encryption information in response to the request signal related to updating the encryption information (e.g., ‘NO’ in operation 501), in operation 509, the electronic device may perform the encrypted communication with the external electronic device 210 included in the group. According to one embodiment, the processor 200 may decrypt the encrypted packet that has been received or is being received from the external electronic device 210 based on the encryption information of the group to which the electronic device 101 is subscribed. The processor 200 may control the output device (not illustrated) of the electronic device 101 to output the decrypted data to the outside. For example, the output device of the electronic device 101 may include the speaker and/or the display.

FIG. 6 is a flowchart (600) for performing the unencrypted communication in the electronic device according to an embodiment of the disclosure.

According to one embodiment, at least a portion of FIG. 6 may include detailed operations of operations 309 and 311 of FIG. 3. In the following embodiments, each operation may be performed sequentially, but is not necessarily performed sequentially. For example, the order of each operation may be changed, and at least two operations may also be performed in parallel. For example, an electronic device of FIG. 6 may be the electronic device 101 of FIG. 1 or 2.

Referring to FIG. 6, when the electronic device (e.g., the processor 120 of FIG. 1 or the processor 200 of FIG. 2) transmits the request signal related to updating the encryption information to the external electronic device 210 (e.g., operation 307 of FIG. 3), in operation 601, the electronic device may check whether the signal related to the failure to update the encryption information is received in response to the request signal related to updating the encryption information.

According to one embodiment, when the electronic device (e.g., the processor 120 or 200) receives the signal related to the failure to update the encryption information in response to the request signal related to updating the encryption information (e.g., ‘Yes’ in operation 601), in operation 603, the electronic device may check whether the unencrypted menu is configured. According to one embodiment, when the processor 200 receives the signal related to the failure to update the encryption information from the external electronic device 210 through the communication circuit 202, the processor may control the communication circuit 202 to transmit the request signal related to updating the encryption information to the external electronic device 210 for the designated number of times. According to one embodiment, when it is determined that the processor 200 has consecutively failed to update the encryption information of the external electronic device 210 for the designated number of times, the processor 200 may check whether the unencrypted menu is configured. For example, the unencrypted menu may include information related to whether to provide the unencrypted communication.

According to one embodiment, the electronic device (e.g., the processor 120 or 200) may terminate the group communication (or the group call) when the unencrypted menu is configured to the disable state (e.g., ‘No’ in operation 603).

According to one embodiment, when the unencrypted menu is configured to the enable state (e.g., ‘Yes’ in operation 603), in operation 605, the electronic device (e.g., the processor 120 or 200) may output information related to the limitation of the encrypted communication. For example, the information related to the limitation of the encrypted communication may include information for indicating a state in which the encrypted communication may not be provided while the encrypted communication is configured.

According to one embodiment, in operation 607, the electronic device (e.g., the processor 120 or 200) may perform the unencrypted communication. According to one embodiment, the processor 200 may control the output device (not illustrated) of the electronic device 101 to output the data included in the unencrypted packet received from the external electronic device 210 to the outside. For example, the output device of the electronic device 101 may include the speaker and/or the display.

According to one embodiment, when the electronic device (e.g., the processor 120 or 200) receives the signal related to the completion of updating the encryption information in response to the request signal related to updating the encryption information (e.g., ‘NO’ in operation 601), in operation 609, the electronic device may perform the encrypted communication with the external electronic device 210 included in the group.

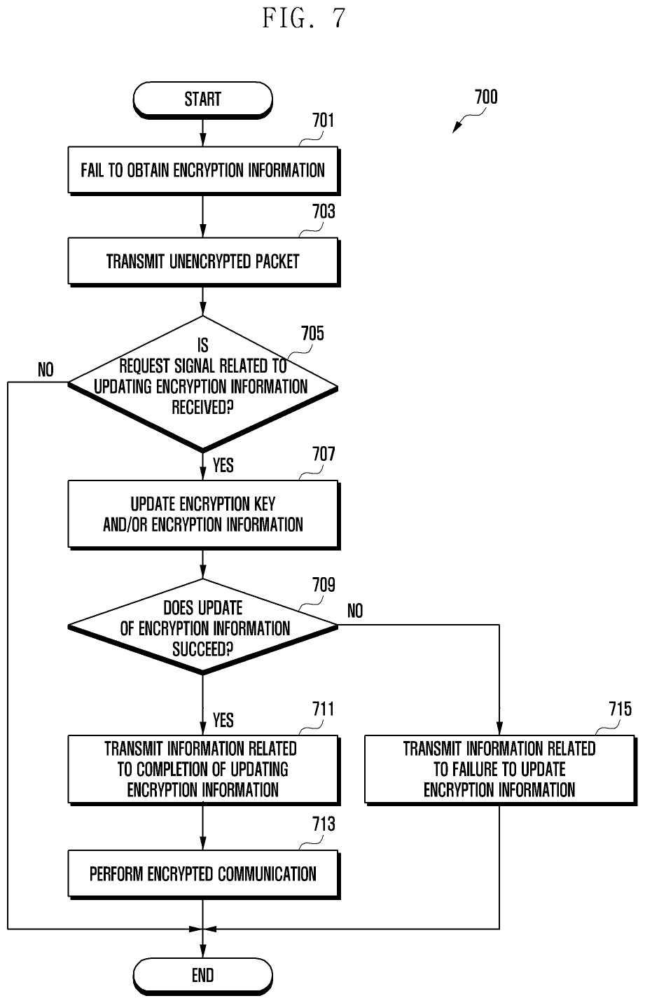

FIG. 7 is a flowchart (700) for updating the encryption information in the external electronic device according to an embodiment of the disclosure.

In the following embodiments, each operation may be performed sequentially, but is not necessarily performed sequentially. For example, the order of each operation may be changed, and at least two operations may also be performed in parallel. For example, the external electronic device of FIG. 7 may be the electronic device 101 of FIG. 1 or the external electronic device 210 of FIG. 2.

Referring to FIG. 7, in operation 701, the external electronic device (e.g., the processor 120 of FIG. 1 or the processor 220 of FIG. 2) may fail to obtain the encryption information related to the group communication (or the group call). According to one embodiment, the processor 220 may obtain (or receive) the account and/or the password related to the mission critical function based on the execution of the application program related to the mission critical function. According to one embodiment, the processor 220 may obtain the information related to accessing (or registering with) the MCPTX/media server when the processor 220 is logged in to the MCPTX/media server based on the account and/or the password related to the mission critical function. According to one embodiment, the processor 220 may control the communication circuit 222 to access (or register with) the MCPTX/media server based on the information related to accessing (or registering with) the MCPTX/media server. For example, the access to (or registration with) the MCPTX/media server may include a series of operations in which the external electronic device 210 establishes the communication link with the MCPTX/media server, which is the network entity, through the base station. According to one embodiment, the processor 200 may obtain the encryption information related to the group communication (or the group call) before, during, or after the access to the MCPTX/media server. For example, the processor 220 may obtain the identification information (e.g., URI) related to the group to which the external electronic device 210 is subscribed from the CMS. For example, the encryption information may include the TGK (e.g., GMK), the RAND, the CSB-ID, and/or the CS-ID, which are the information required to derive the key (e.g., the SRTP session key) for encrypting and/or decrypting the packet (or data) transmitted and/or received during the group communication (or the group call).

For example, the processor 220 may obtain the configuration information related to the group to which the external electronic device 210 is subscribed from the GMS based on the identification information related to the group to which the external electronic device 210 is subscribed obtained from the CMS. For example, the processor 220 may obtain the information related to, for example, the root certificate and/or the encryption key (or the user key) (e.g., the KMS key) from the KMS.

For example, when the processor 220 determines that the group to which the external electronic device 210 is subscribed supports the encrypted communication, the processor 220 may control the communication circuit 222 to transmit the request signal (e.g., SUBSCRIBE) related to the encryption information to the GMS through the MCPTX/media server. When the processor 220 receives the response signal corresponding to the request signal related to the encryption information from the GMS through the MCPTX/media server, the processor 220 may decrypt the response signal based on the encryption key obtained from the KMS. For example, the response signal is the message (e.g., the MIKEY message) encrypted with the encryption key (e.g., the KMS key), and may include the GMK GKTP. For example, when the processor 220 fails to decrypt the response signal based on the encryption key obtained from the KMS, it may be determined that the processor 220 fails to obtain the encryption information related to the group to which the external electronic device 210 is subscribed.

According to one embodiment, the processor 220 may control the communication circuit 222 to transmit the information related to the group communication to the MCPTX/media server based on the occurrence of the event related to the start of the group communication (or the group call) while accessing (or registering with) the MCPTX/media server. According to one embodiment, when the processor 220 receives the response signal (e.g., 200 OK) corresponding to the information related to the group communication from the MCPTX/media server through the communication circuit 222, the processor 220 may determine, through the MCPTX/media server, that the group communication with at least one another external electronic device (e.g., the electronic device 101) included in the group to which the external electronic device 210 is subscribed is configured.

According to one embodiment, in operation 703, the external electronic device (e.g., the processor 120 or 220) may transmit the unencrypted packet (e.g., RTP) to the electronic device 101 based on the failure to obtain the encryption information.

According to one embodiment, in operation 705, the external electronic device (e.g., the processor 120 or 220) may check whether the request signal related to updating the encryption information is received from the electronic device 101.

According to one embodiment, the external electronic device (e.g., the processor 120 or 220) may terminate one embodiment for updating the encryption information when the request signal related to updating the encryption information is not received (e.g., ‘No’ in operation 705).

According to one embodiment, when the external electronic device (e.g., the processor (120 or 220) receives the request signal related to updating the encryption information (e.g., ‘Yes’ in operation 705), in operation 707, the external electronic device may update the encryption key and/or the encryption information related to the group to which the external electronic device 210 is subscribed. According to one embodiment, when the processor 220 receives the request signal related to updating the encryption information from the electronic device 101, the processor 220 may check through the GMS whether the group to which the external electronic device 210 is subscribed supports the encrypted communication. According to one embodiment, when the processor 220 determines that the group to which the external electronic device 210 is subscribed supports the encrypted communication, the processor 220 may update the encryption key (or the user key) through the KMS.

According to one embodiment, the processor 220 may obtain the encryption information for the encrypted communication with at least one electronic device 101 included in the group and/or another external electronic device based on the information related to the encryption key updated through the KMS. For example, the processor 220 may control the communication circuit 222 to transmit the update signal related to the encryption information to the GMS through the MCPTX/media server. The processor 220 may receive the response signal corresponding to the update signal related to the encryption information from the GMS through the MCPTX/media server. The processor 220 may decrypt the response signal based on the encryption key updated through the KMS.

According to one embodiment, in operation 709, it may be checked whether the external electronic device (e.g., the processor 120 or 220) succeeds in updating the encryption key and/or the encryption information related to the group to which the external electronic device 210 is subscribed. According to one embodiment, when the processor 220 succeeds in decrypting the response signal corresponding to the update signal related to the encryption information received from the MCPTX/media server based on the encryption key updated through the KMS, it may be determined that the processor 220 succeeds in updating the encryption key and/or the encryption information related to the group to which the external electronic device 210 is subscribed. According to one embodiment, when the processor 220 fails to decrypt the response signal corresponding to the update signal related to the encryption information received from the MCPTX/media server based on the encryption key updated through the KMS, it may be determined that the processor 220 fails to update the encryption key and/or the encryption information related to the group to which the external electronic device 210 is subscribed.

According to one embodiment, when it is determined that the external electronic device (e.g., the processor 120 or 220) succeeds in updating the encryption key and/or the encryption information related to the group to which the external electronic device 210 is subscribed (e.g., ‘Yes’ in operation 709), in operation 711, the external electronic device may transmit the signal related to the completion of updating the encryption information to the electronic device 101.

According to one embodiment, in operation 713, the external electronic device (e.g., the processor 120 or 220) may perform the encrypted communication with the electronic device 101. According to one embodiment, the processor 220 may control the communication circuit 222 to transmit the encrypted packet (e.g., SRTP) to the electronic device 101 based on the encryption information related to the group to which the external electronic device 210 is subscribed.

According to one embodiment, when it is determined that the external electronic device (e.g., the processor 120 or 220) fails to update the encryption key and/or the encryption information related to the group to which the external electronic device 210 is subscribed (e.g., ‘No’ in operation 709), in operation 715, the external electronic device may transmit the signal related to the failure to update the encryption information to the electronic device 101.

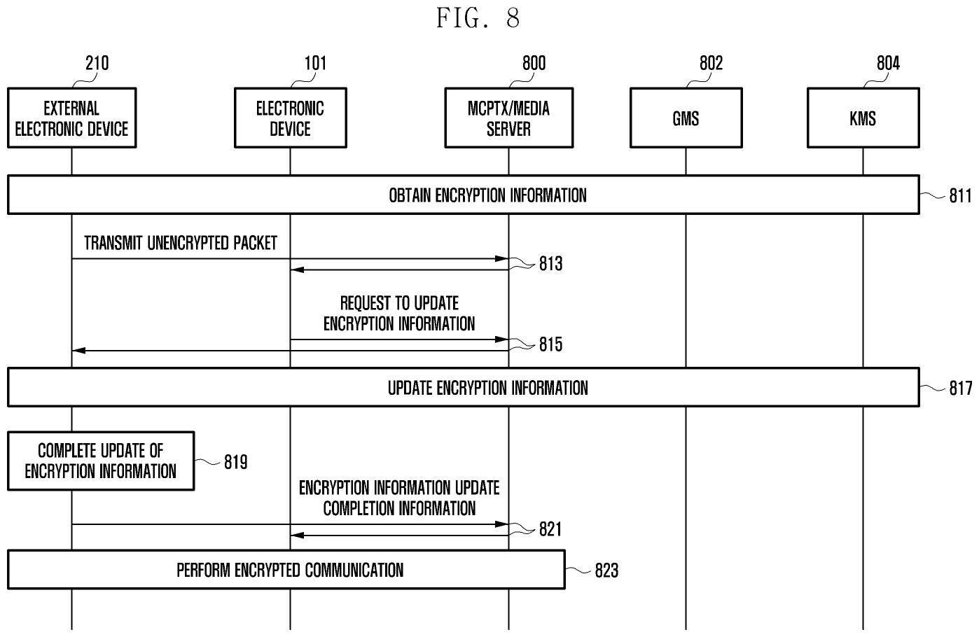

FIG. 8 is an example in which the electronic device performs the encrypted communication with the external electronic device according to an embodiment of the disclosure.

Referring to FIG. 8, the electronic device 101 may obtain the encryption information related to the group communication (or the group call) of the group to which the electronic device 101 is subscribed in operation 811. According to one embodiment, the electronic device 101 may obtain (or receive), from a GMS 802, the configuration information related to the group to which the electronic device 101 is subscribed based on the identification information (e.g., URI) related to the group to which the electronic device 101 is subscribed, obtained from the CMS. According to one embodiment, the electronic device 101 may obtain the information related to, for example, the root certificate and/or the encryption key (or the user key) (e.g., the KMS key) from a KMS 804. According to one embodiment, when the electronic device 101 determines that the group to which the electronic device 101 is subscribed supports the encrypted communication, the electronic device 101 may decrypt the encryption information obtained from the GMS 802 through the MCPTX/media server based on the encryption key obtained from the KMS 804. According to one embodiment, when the electronic device 101 succeeds in decrypting the encryption information obtained from the GMS 802, the electronic device 101 may obtain the encryption information related to the group to which the electronic device 101 is subscribed. According to one embodiment, the electronic device 101 may transmit the information related to the group communication to the MCPTX/media server based on the occurrence of the event related to the start of the group communication (or the group call) while accessing (or registering with) the MCPTX/media server. When the electronic device 101 receives the response signal (e.g., 200 OK) corresponding to the information related to the group communication from the MCPTX/media server, the electronic device 101 may determine, through the MCPTX/media server, that the group communication with at least one external electronic device 210 included in the group to which the electronic device 101 is subscribed is configured. For example, the configuration of the group communication may include a series of operations for establishing the group session for the group communication with at least one external electronic device 210 included in the group to which the electronic device 101 is subscribed.

According to one embodiment, the external electronic device 210 may obtain the encryption information related to the group communication (or the group call) of the group to which the external electronic device 210 is subscribed in operation 811. According to one embodiment, the external electronic device 210 may obtain the configuration information related to the group to which the external electronic device 210 is subscribed from the GMS 802 based on the identification information (e.g., URI) related to the group to which the external electronic device 210 is subscribed, obtained from the CMS. According to one embodiment, the external electronic device 210 may obtain the information related to, for example, the root certificate and/or the encryption key (or the user key) (e.g., the KMS key) from a KMS 804. According to one embodiment, when the external electronic device 210 determines that the group to which the external electronic device 210 is subscribed supports the encrypted communication, the external electronic device 210 may decrypt the encryption information obtained from the GMS 802 through the MCPTX/media server based on the encryption key obtained from the KMS 804. According to one embodiment, when the external electronic device 210 fails to decrypt the encryption information obtained from the GMS 802, the external electronic device 210 may fail to obtain the encryption information related to the group to which the electronic device 101 is subscribed. According to one embodiment, the external electronic device 210 may transmit the information related to the group communication to the MCPTX/media server based on the occurrence of the event related to the start of the group communication (or the group call) while accessing (or registering with) the MCPTX/media server. When the external electronic device 210 receives the response signal (e.g., 200 OK) corresponding to the information related to the group communication from the MCPTX/media server, the external electronic device 210 may determine that the group communication with at least one another external electronic device (e.g., electronic device 101) included in the group to which the external electronic device 210 is subscribed through the MCPTX/media server is configured.

According to one embodiment, when the external electronic device 210 is included in the same group as the electronic device 101, the external electronic device 210 may transmit the unencrypted packet (e.g., RTP) to the electronic device 101 through the MCPTX/media server 800 in operation 813. For example, the MCPTX/media server 800 is the server that supports the mission critical function, and may include the media server that processes the voice data and the MCPTX server that processes the encryption information related to the group call.

According to one embodiment, when the electronic device 101 receives the unencrypted packet (e.g., RTP) from the external electronic device 210 while determining that the electronic device 101 provides the encrypted communication, the electronic device 101 may transmit the request signal related to updating the encryption information to the external electronic device 210 through the MCPTX/media server 800 in operation 815. According to one embodiment, when the electronic device 101 decrypts the encrypted information received from the GMS based on the encryption key obtained from the KMS 804, it may be determined that the electronic device 101 may provide the encrypted communication. According to one embodiment, when the electronic device 101 receives the packet from the external electronic device 210 while determining that the electronic device 101 provides the encrypted communication, the electronic device 101 may check whether the corresponding packet is the encrypted packet (e.g., SRTP). For example, when the master key identifier (MKI) exists in the packet received from the external electronic device 210, the electronic device 101 may determine that the packet received from the external electronic device 210 is the encrypted packet. For example, when the MKI does not exist in the packet received from the external electronic device 210, the electronic device 101 may determine that the packet received from the external electronic device 210 is the unencrypted packet (e.g., the real-time transport protocol (RTP)).

According to one embodiment, when it is determined that the electronic device 101 receives the unencrypted packet from the external electronic device 210 while obtaining the encryption information related to the group call, the electronic device 101 may determine that the encryption information of the external electronic device 210 needs to be updated. According to one embodiment, the electronic device 101 may check whether the group to which the electronic device 101 is subscribed supports the encrypted communication through the GMS 802 based on the determination that the encryption information of the external electronic device 210 needs to be updated. According to one embodiment, when the electronic device 101 determines that the group to which the electronic device 101 is subscribed supports the encrypted communication, the electronic device 101 may transmit the request signal related to updating the encryption information to the external electronic device 210 through the MCPTX/media server 800. According to one embodiment, when the electronic device 101 determines that the group to which the electronic device 101 is subscribed supports the encrypted communication, the electronic device 101 may update the encryption key and/or the encryption information through the KMS 804 and/or the GMS 802. For example, the request signal related to updating the encryption information may include the update signal with the P-Refresh-Security header set as required.

According to one embodiment, the external electronic device 210 may update the encryption key and/or the encryption information based on the request signal related to updating the encryption information received from the electronic device 101 in operation 817. According to one embodiment, the external electronic device 210 may check whether the group to which the external electronic device 210 is subscribed supports the encrypted communication through the GMS 802 based on the request signal related to updating the encryption information received from the electronic device 101. According to one embodiment, when the external electronic device 210 determines that the group to which the external electronic device 210 is subscribed supports the encrypted communication, the external electronic device 210 may access the KMS 804 to perform downloading of the KMC root certificate and provisioning, thereby updating the encryption key.

According to one embodiment, the external electronic device 210 may obtain the encryption information for the encrypted communication with at least one electronic device 101 included in the group and/or another external electronic device based on the information related to the encryption key updated through the KMS 804. For example, the external electronic device 210 may transmit the update signal (e.g., SIP SUBSCRIBE or SUBSCRIBE) related to the encryption information to the GMS 802 through the MCPTX/media server 800. The external electronic device 210 may receive the encrypted encryption information from the GMS 802 through the MCPTX/media server 800. The external electronic device 210 may decrypt the encrypted encryption information obtained from the GMS 802 based on the encryption key updated through the KMS 804.

According to one embodiment, when the external electronic device 210 succeeds in decrypting the encrypted information obtained from the GMS 802 in operation 819, the external electronic device 210 may transmit the signal (e.g., 200 OK) related to the completion of updating the encryption information to the electronic device 101 through the MCPTX/media server 800 in operation 821.

According to one embodiment, the electronic device 101 and the external electronic device 210 may perform the encrypted communication based on the success of updating the encryption information of the external electronic device 210 (in operation 823). According to one embodiment, the external electronic device 210 may transmit the encrypted packet to the electronic device 101 based on the encryption information related to the group to which the external electronic device 210 is subscribed. The electronic device 101 may decrypt the encrypted packet received from the external electronic device 210 based on the encryption information related to the group to which the electronic device 101 is subscribed. The electronic device 101 may control the output device (not illustrated) of the electronic device 101 to output the decrypted data to the outside. For example, the output device of the electronic device 101 may include the speaker and/or the display.

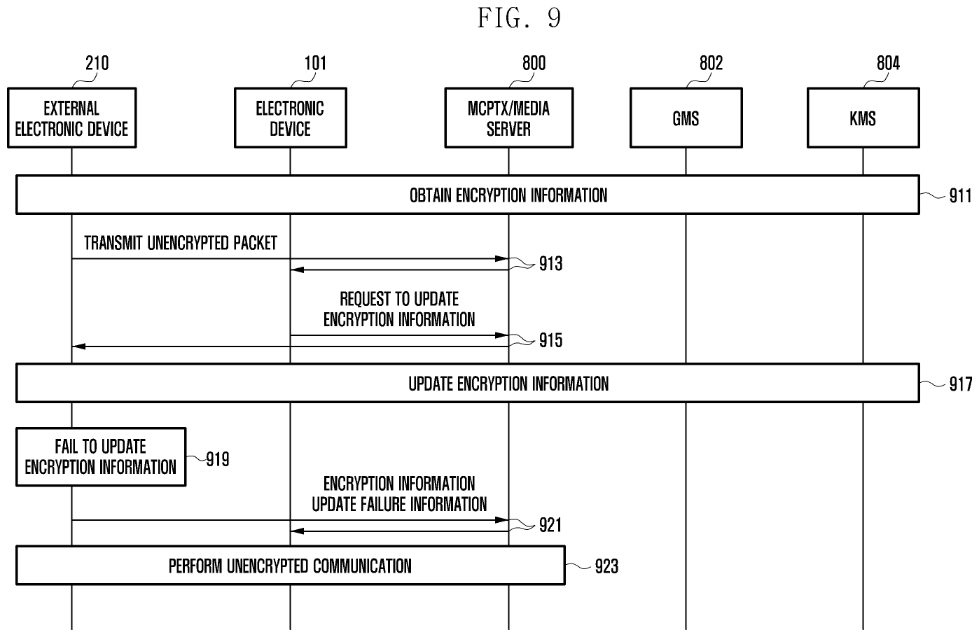

FIG. 9 is an example in which the electronic device performs the unencrypted communication with the external electronic device according to an embodiment of the disclosure.

Referring to FIG. 9, the electronic device 101 may obtain the encryption information related to the group communication (or the group call) of the group to which the electronic device 101 is subscribed in operation 911. According to one embodiment, the electronic device 101 may configure the group communication based on the occurrence of the event related to the start of the group communication (or the group call) while accessing (or registering with) the MCPTX/media server. For example, the configuration of the group communication may include a series of operations for establishing the group session for the group communication with at least one external electronic device 210 included in the group to which the electronic device 101 is subscribed.

According to one embodiment, the external electronic device 210 may obtain the encryption information related to the group communication (or the group call) of the group to which the external electronic device 210 is subscribed in operation 911. According to one embodiment, the external electronic device 210 may configure the group communication based on the occurrence of the event related to the start of the group communication (or the group call) while accessing (or registering with) the MCPTX/media server. For example, the configuration of the group communication may include a series of operations for establishing the group session for the group communication with at least one another external electronic device (e.g., the electronic device 101) included in the group to which the external electronic device 210 is subscribed.

According to one embodiment, when the external electronic device 210 is included in the same group as the electronic device 101, the external electronic device 210 may transmit the unencrypted packet (e.g., RTP) to the electronic device 101 through the MCPTX/media server 800 in operation 913. For example, the MCPTX/media server 800 is the server that supports the mission critical function, and may include the media server that processes the voice data and the MCPTX server that processes the encryption information related to the group call.

According to one embodiment, when the electronic device 101 receives the unencrypted packet (e.g., RTP) from the external electronic device 210 while determining that the electronic device 101 provides the encrypted communication, the electronic device 101 may transmit the request signal related to updating the encryption information to the external electronic device 210 through the MCPTX/media server 800 in operation 915.

According to one embodiment, the external electronic device 210 may update the encryption key and/or the encryption information based on the request signal related to updating the encryption information received from the electronic device 101 in operation 917. According to one embodiment, operations 911 to 917 of FIG. 9 are the same as the operations 811 to 817 of FIG. 8, and thus, a detailed description thereof may be omitted.

According to one embodiment, when the group to which the external electronic device 210 is subscribed does not support the encrypted communication or when the external electronic device 210 fails to decrypt the encrypted information obtained from the GMS 802 in operation 919, the external electronic device 210 may transmit the signal related to the failure to update the encryption information to the electronic device 101 through the MCPTX/media server 800 in operation 921.

According to one embodiment, when it is determined that the electronic device 101 and the external electronic device 210 fails to update the encryption information of the external electronic device 210, the electronic device 101 and the external electronic device 210 may repeat the operations 915 to 917 for the designated number of times.

According to one embodiment, when it is determined that the electronic device 101 has consecutively failed to update the encryption information of the external electronic device 210 for the designated number of times, the electronic device 101 may determine whether to perform the unencrypted communication. According to one embodiment, when the electronic device 101 detects the input related to performing the unencrypted communication in response to the output of the information related to receiving the unencrypted packet through the output device of the electronic device 101 as illustrated in FIG. 5, it may be determined that the electronic device 101 provides the unencrypted communication. According to one embodiment, as illustrated in FIG. 5, when the electronic device 101 does not detect the input related to performing the unencrypted communication or detects the input related to the non-performance of the unencrypted communication in response to the output of information related to receiving the unencrypted packet through the output device of the electronic device 101, it may be determined that the electronic device 101 does not provide the unencrypted communication.

According to one embodiment, as illustrated in FIG. 6, when the unencrypted menu is configured to the enable state, it may be determined that the electronic device 101 provides the unencrypted communication. According to one embodiment, as illustrated in FIG. 6, when the unencrypted menu is configured to the disable state, it may be determined that the electronic device 101 does not provide the unencrypted communication.

According to one embodiment, when it is determined that the electronic device 101 provides the unencrypted communication, the electronic device 101 may perform the unencrypted communication with the external electronic device 210 in operation 923. According to one embodiment, the electronic device 101 may output the data included in the unencrypted packet received from the external electronic device 210 through the output device (not illustrated) of the electronic device 101.

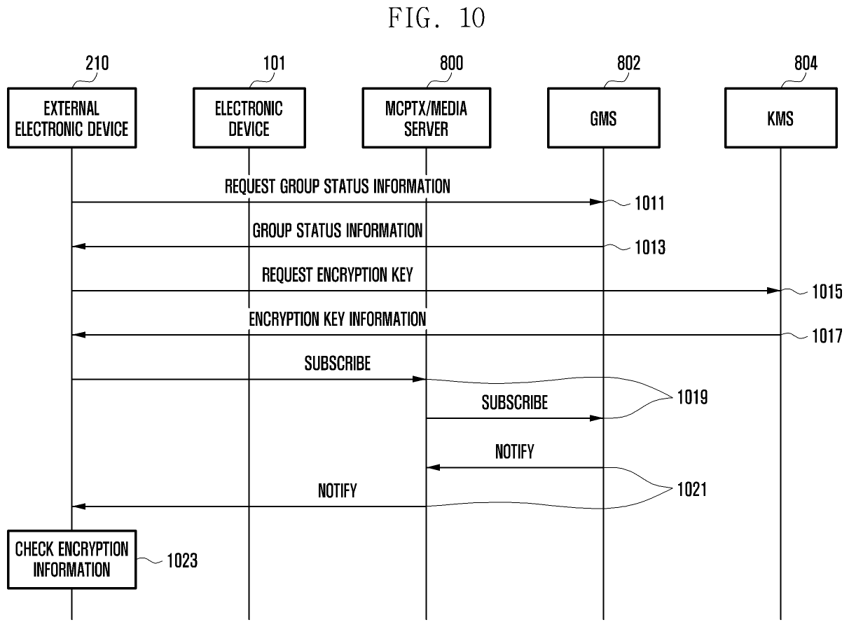

FIG. 10 is an example updating the encryption information in the external electronic device according to an embodiment of the disclosure.

Referring to FIG. 10, the external electronic device 210 may transmit a request signal related to group status information to the GMS 802 based on the request signal related to updating the encryption information received from the electronic device 101 in operation 1011.

According to one embodiment, the GMS 802 may transmit the configuration information related to the group to which the external electronic device 210 is subscribed to the external electronic device 210 based on the request signal related to the group status information in operation 1013. For example, the configuration information related to the group may include at least one of the information (e.g., the SRTP enable information) related to whether the group supports the encrypted communication, the information related to the external electronic device 210 included in the group, and/or the communication type (e.g., the call type) of the group.

According to one embodiment, the external electronic device 210 may check whether the group to which the external electronic device 210 is subscribed supports the encrypted communication based on the configuration information related to the group received from the GMS 802.

According to one embodiment, when the external electronic device 210 determines that the group to which the external electronic device 210 is subscribed supports the encrypted communication, the external electronic device 210 may transmit the request signal related to the encryption key to the KMS 804 in operation 1015.

According to one embodiment, the KMS 804 may transmit the root certificate and the encryption key to the external electronic device 210 based on the request signal related to the encryption key in operation 1017.

According to one embodiment, the external electronic device 210 may transmit the update signal (e.g., subscribe) related to the encryption information to the GMS 802 through the MCPTX/media server 800 in operation 1019.

According to one embodiment, the GMS 802 may transmit (e.g., notify) the encryption information related to the group to which the external electronic device 210 is subscribed to the external electronic device 210 through the MCPTX/media server 800 based on the update signal related to the encryption information in operation 1021. For example, the encryption information related to the group to which the external electronic device 210 is subscribed may be encrypted based on the encryption key related to the group to which the external electronic device 210 is subscribed.

According to one embodiment, the external electronic device 210 may decrypt the encrypted information received from the GMS 802 through the MCPTX/media server 800 based on the encryption key updated through the KMS 804 in operation 1023.

According to one embodiment, the electronic device 101 and the external electronic device 210 may perform operations 1011 to 1017 of FIG. 10 based on a hyper-text transfer protocol (HTTP).

According to one embodiment, the electronic device 101 and the external electronic device 210 may perform operations 1019 to 1021 of FIG. 10 based on a session initiation protocol (SIP).

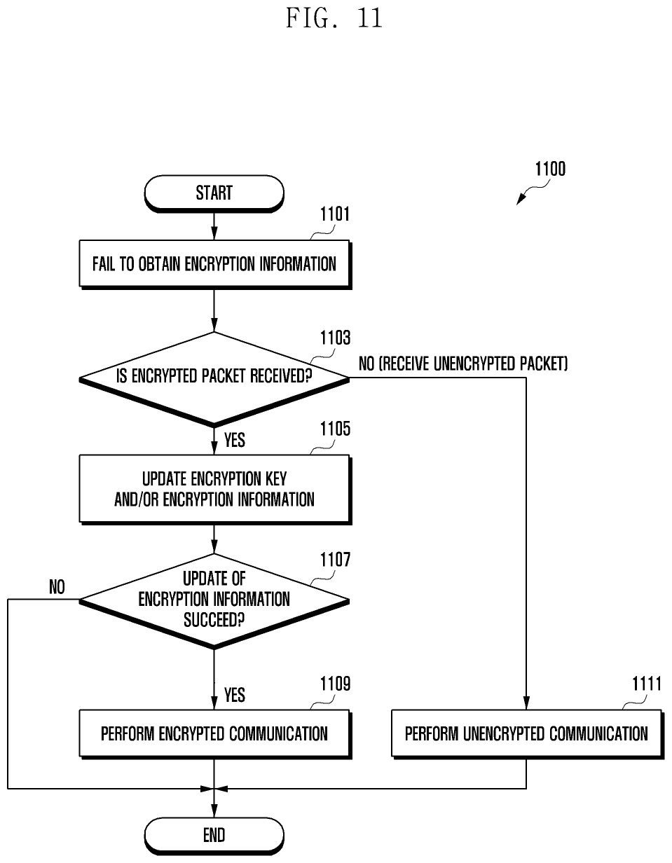

FIG. 11 is a flowchart (1100) for updating the encryption information in the electronic device according to an embodiment of the disclosure.

In the following embodiments, each operation may be performed sequentially, but is not necessarily performed sequentially. For example, the order of each operation may be changed, and at least two operations may also be performed in parallel. For example, an electronic device of FIG. 11 may be the electronic device 101 of FIG. 1 or 2.

Referring to FIG. 11, in operation 1101, the electronic device (e.g., the processor 120 of FIG. 1 or the processor 200 of FIG. 2) may fail to obtain the encryption information related to the group communication (or the group call). According to one embodiment, the processor 200 may obtain (or receive) the account and/or the password related to the mission critical function based on the execution of the application program related to the mission critical function. According to one embodiment, the processor 200 may obtain the information related to accessing (or registering with) the MCPTX/media server when the processor 200 is logged in to the MCPTX/media server based on the account and/or the password related to the mission critical function. According to one embodiment, the processor 200 may control the communication circuit 202 to access (or register with) the MCPTX/media server based on the information related to accessing (or registering with) the MCPTX/media server. For example, the access to (or registration with) the MCPTX/media server may include a series of operations in which the electronic device 101 establishes the communication link with the MCPTX/media server, which is the network entity, through the base station. According to one embodiment, the processor 200 may obtain the encryption information related to the group communication (or the group call) before, during, or after the access to the MCPTX/media server. For example, the processor 200 may obtain the identification information (e.g., URI) related to the group to which the electronic device 101 is subscribed from the CMS. For example, the encryption information may include the TGK (e.g., GMK), the RAND, the CSB-ID, and/or the CS-ID, which are the information required to derive the key (e.g., the SRTP session key) for encrypting and/or decrypting the packet (or data) transmitted and/or received during the group communication (or the group call). For example, the derivation of the key for encrypting and/or decrypting the packet (or data) may include a series of operations of generating the SRTP master key and/or the SRTP master salt based on information (e.g., TGK, RAND, CSB-ID, and/or CS-ID) required to derive the key for encrypting and/or decrypting the packet (or data), and generating the SRTP session key based on the SRTP master key and/or the SRTP master salt.

For example, the processor 200 may obtain the configuration information related to the group to which the electronic device 101 is subscribed from the GMS based on the identification information related to the group to which the electronic device 101 is subscribed obtained from the CMS. For example, the processor 200 may obtain the information related to, for example, the root certificate and/or the encryption key (or the user key) (e.g., the KMS key) from the KMS.

For example, when the processor 200 determines that the group to which the electronic device 101 is subscribed supports the encrypted communication, the processor 200 may control the communication circuit 202 to transmit the request signal (e.g., SUBSCRIBE) related to the encryption information to the GMS through the MCPTX/media server. When the processor 200 receives the response signal corresponding to the request signal related to the encryption information from the GMS through the MCPTX/media server, the processor 200 may decrypt the response signal based on the encryption key obtained from the KMS to obtain the encryption information related to the group to which the electronic device 101 is subscribed. For example, the response signal is the message (e.g., the MIKEY message) encrypted with the encryption key (e.g., the KMS key), and may include the GMK GKTP. For example, when the processor 200 fails to decrypt the response signal based on the encryption key obtained from the KMS, the processor 200 may determine that the electronic device 101 fails to obtain the encryption information related to the group to which the electronic device 101 is subscribed.

According to one embodiment, the processor 200 may control the communication circuit 202 to transmit the information related to the group communication to the MCPTX/media server based on the occurrence of the event related to the start of the group communication (or the group call) while accessing (or registering with) the MCPTX/media server. According to one embodiment, when the processor 200 receives the response signal (e.g., 200 OK) corresponding to the information related to the group communication from the MCPTX/media server through the communication circuit 202, the processor 200 may determine, through the MCPTX/media server, that the group communication with at least one external electronic device 210 included in the group to which the electronic device 101 is subscribed is configured. For example, the configuration of the group communication may include a series of operations for establishing the group session for the group communication with at least one external electronic device 210 included in the group to which the electronic device 101 is subscribed.

According to one embodiment, in operation 1103, the electronic device (e.g., the processor 120 or 200) may check whether the encrypted packet (e.g., SRTP) is received from the external electronic device 210 included in the group. According to one embodiment, when the processor 200 fails to decrypt the encrypted information received from the GMS based on the encryption key obtained from the KMS, it may be determined that the processor 200 may not provide the encrypted communication. According to one embodiment, when the processor 200 receives the packet from the external electronic device 210 while determining that the processor 200 may not provide the encrypted communication, the processor 200 may check whether the corresponding packet is the encrypted packet (e.g., SRTP). For example, when the master key identifier (MKI) exists in the packet received from the external electronic device 210, the processor 200 may determine that the packet received from the external electronic device 210 is the encrypted packet. For example, when the MKI does not exist in the packet received from the external electronic device 210, the processor 200 may determine that the packet received from the external electronic device 210 is the unencrypted packet (e.g., the real-time transport protocol (RTP)).

According to one embodiment, when the electronic device (e.g., the processor 120 or 200) receives the unencrypted packet (e.g., RTP) from the external electronic device 210 included in the group (e.g., ‘No’ in operation 1103), in operation 1111, the electronic device may perform the unencrypted communication with the external electronic device 210 included in the group. According to one embodiment, the processor 200 may control the output device (not illustrated) of the electronic device 101 to output the data included in the unencrypted packet received from the external electronic device 210 to the outside. For example, the output device of the electronic device 101 may include the speaker and/or the display.

According to one embodiment, when the electronic device (e.g., the processor 120 or 200) receives the encrypted packet (e.g., SRTP) from the external electronic device 210 included in the group (e.g., ‘Yes’ in operation 1103), in operation 1105, the electronic device may update the encryption key and/or the encryption information related to the group to which the electronic device 101 is subscribed. According to one embodiment, when the processor 200 receives the encrypted packet from the external electronic device 210 without obtaining the encryption information related to the group call, the processor 200 may determine that the encryption information of the electronic device 101 needs to be updated. According to one embodiment, based on the determination that the encryption information of the electronic device 101 needs to be updated, the processor 200 may check whether the group to which the electronic device 101 is subscribed supports the encrypted communication through the GMS. According to one embodiment, when the processor 200 determines that the group to which the electronic device 101 is subscribed supports the encrypted communication, the processor 200 may access the KMS to perform the downloading of the KMC root certificate and the provisioning, thereby updating the encryption key.

According to one embodiment, the processor 200 may transmit the update signal (e.g., subscribe) related to the encryption information to the GMS through the MCPTX/media server. The processor 200 may decrypt the encrypted information received from the GMS through the MCPTX/media server with the encryption key updated through the KMS.

According to one embodiment, in operation 1107, it may be checked whether the electronic device (e.g., the processor 120 or 200) succeeds in updating the encryption key and/or the encryption information related to the group to which the electronic device 101 is subscribed. According to one embodiment, when the group to which the electronic device 101 is subscribed supports the encrypted communication and the processor 200 succeeds in decrypting the encrypted information received from the GMS, it may be determined that the processor 200 succeeds in updating the encryption key and/or the encryption information related to the group to which the electronic device 101 is subscribed. According to one embodiment, when the group to which the electronic device 101 is subscribed does not support the encrypted communication or the processor 200 fails to decrypt the encrypted information received from the GMS, it may be determined that the processor 200 fails to update the encryption key and/or the encryption information related to the group to which the electronic device 101 is subscribed.

According to one embodiment, when it is determined that the electronic device (e.g., the processor 120 or 200) fails to update the encryption key and/or the encryption information related to the group to which the electronic device 101 is subscribed (e.g., ‘No’ in operation 1107), the electronic device may terminate one embodiment for controlling the update of the encryption information of the electronic device 101. According to one embodiment, the processor 200 may perform the update of the encryption key and/or the encryption information of the electronic device 101 for the designated number of times. According to one embodiment, when it is determined that the processor 200 has consecutively failed to update the encryption key or the encryption information of the electronic device 101 for the designated number of times, the processor 200 may control the communication circuit 202 to provide the unencrypted communication, as illustrated in FIG. 5 or 6.

According to one embodiment, when it is determined that the electronic device (e.g., the processor 120 or 200) succeeds in updating the encryption key and/or the encryption information related to the group to which the electronic device 101 is subscribed (e.g., ‘Yes’ in operation 1107), in operation 1109, the electronic device may perform the encrypted communication with the external electronic device 210 included in the group. According to one embodiment, the processor 200 may decrypt the encrypted packet that has been received or is being received from the external electronic device 210 based on the encryption information of the group to which the electronic device 101 is subscribed. The processor 200 may control the output device (not illustrated) of the electronic device 101 to output the decrypted data to the outside. For example, the output device of the electronic device 101 may include the speaker and/or the display.

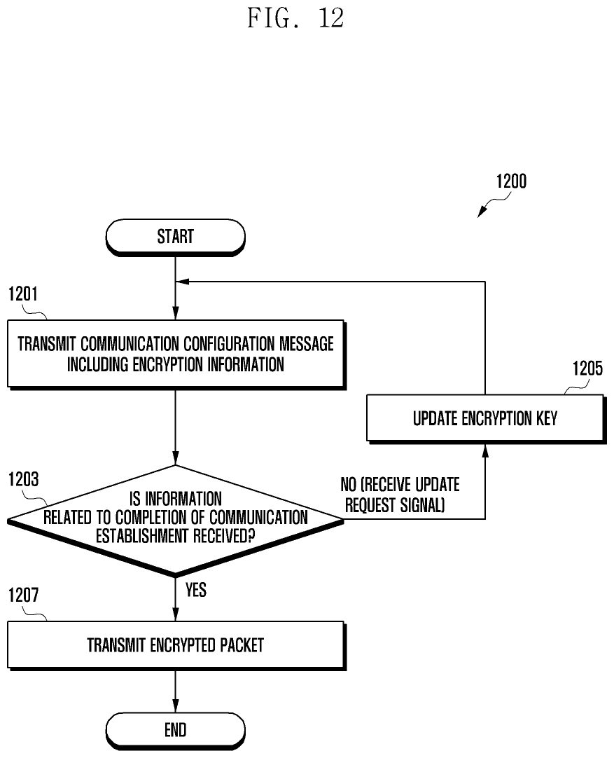

FIG. 12 is a flowchart (1200) for updating the encryption information in the external electronic device according to an embodiment of the disclosure.

In the following embodiments, each operation may be performed sequentially, but is not necessarily performed sequentially. For example, the order of each operation may be changed, and at least two operations may also be performed in parallel. For example, an external electronic device of FIG. 12 may be the electronic device 101 of FIG. 1 or the external electronic device 210 of FIG. 2.

Referring to FIG. 12, in operation 1201, the external electronic device (e.g., the processor 120 of FIG. 1 or the processor 220 of FIG. 2) may transmit a communication (or call) configuration message (e.g., INVITE) including the encryption information to the electronic device 101 in order to perform individual communication (or the individual call) with the electronic device 101. According to one embodiment, the processor 220 may check whether to perform media encryption of the individual communication (e.g., allowed media protection) from a user profile stored in the configuration management server (CMS). According to one embodiment, when the processor 220 is configured to perform the media encryption of the individual communication, the processor 220 may control the communication circuit 222 to transmit the communication (or call) configuration message including the encryption information for the individual communication to the electronic device 101. For example, the communication configuration message may include information indicating that the external electronic device 210 is configured to have a function of processing a request for updating the encryption information from the electronic device 101. For example, the information indicating that the function for processing a request for updating the encryption information is configured may be included in “pck-security-refresh” of a “Supported” header of the communication configuration message (e.g., INVITE). For example, the encryption information may be generated by the external electronic device 210 and encrypted based on the encryption key (e.g., the KMS key). For example, the encryption information is information required to derive the key for encrypting and/or decrypting the packet (or data) transmitted and/or received during the individual communication (or the individual call), and may include the traffic generating key (TGK) (e.g., the private call key (PCK)), the random value (RAND), the crypto session bundle identifier (CSB-ID), and/or the crypto session identifier (CS-ID). For example, the key for encrypting and/or decrypting the packet (or data) may include the security real-time transport protocol (SRTP) session key.

According to one embodiment, in operation 1203, the external electronic device (e.g., the processor 120 or 220) may check whether the information related to the completion of the communication establishment (e.g., 200 OK) is received from the electronic device 101. For example, when the electronic device 101 succeeds in decrypting the encryption information included in the communication configuration message, the information related to the completion of the communication establishment may be transmitted by the electronic device 101.

According to one embodiment, when the signal related to the update request is received from the electronic device 101 (e.g., ‘No’ in operation 1203), in operation 1205, the external electronic device (e.g., the processor 120 or 220) may update the encryption key of the external electronic device 210. According to one embodiment, when the processor 220 receives the signal related to the update request from the electronic device 101, the processor 220 may update the encryption key (or the user key) (e.g., the KMS key) through the KMS. For example, the signal related to the update request may include “180 Ringing” with the “pck-security-refresh” included in the “Required” header.

According to one embodiment, in operation 1201, the external electronic device (e.g., the processor 120 or 220) may transmit the update message (e.g., UPDATE) including the encryption information of the external electronic device 210 to the electronic device 101 based on receiving the update request signal from the electronic device 101. For example, the encryption information included in the update message may be encrypted based on the updated encryption key of the external electronic device 210.

According to one embodiment, when the external electronic device (e.g., the processor 120 or 220) receives the information related to the completion of the communication establishment from the electronic device 101 (e.g., ‘Yes’ in operation 1203), in operation 1207, the external electronic device may transmit the encrypted packet (e.g., SRTP) to the electronic device 101. For example, the encrypted packet may be encrypted based on the SRTP session key generated based on the encryption information to perform the individual communication (or the individual call). For example, the SRTP session key may be generated based on the SRTP master key and/or the SRTP master salt generated based on the encryption information to perform the individual communication (or the individual call).

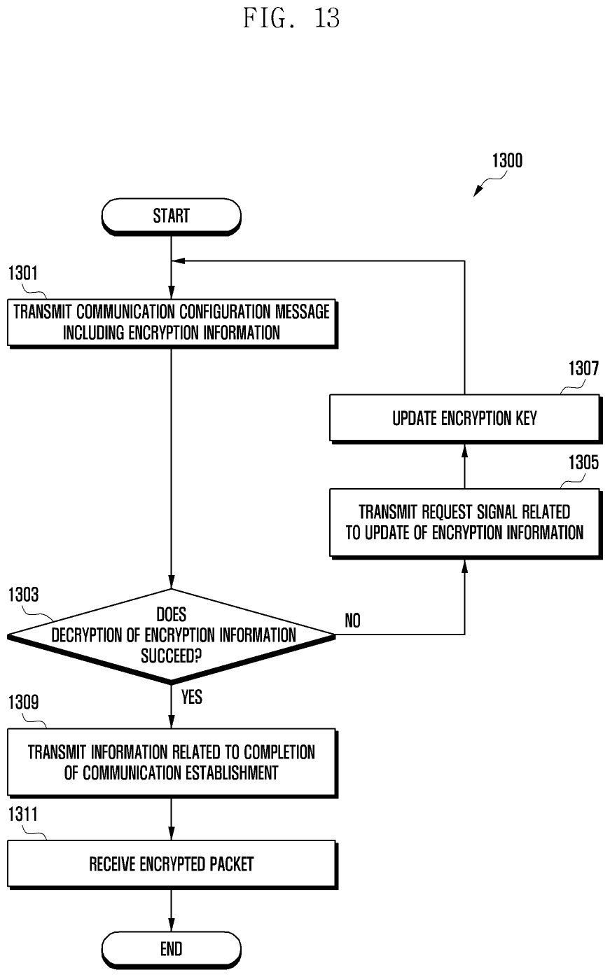

FIG. 13 is a flowchart (1300) for updating the encryption information in the electronic device according to an embodiment of the disclosure.

In the following embodiments, each operation may be performed sequentially, but is not necessarily performed sequentially. For example, the order of each operation may be changed, and at least two operations may also be performed in parallel. For example, an electronic device of FIG. 13 may be the electronic device 101 of FIG. 1 or 2.

According to one embodiment referring to FIG. 13, in operation 1301, the electronic device (e.g., the processor 120 of FIG. 1 or the processor 200 of FIG. 2) may receive the communication (or call) configuration message including the encryption information for performing the individual communication (or the individual call) from the external electronic device 210.

According to one embodiment, in operation 1303, it may be checked whether the electronic device (e.g., the processor 120 or 200) succeeds in decrypting the encryption information included in the communication configuration message received from the external electronic device 210. According to one embodiment, when the communication configuration message received from the external electronic device 210 includes the information indicating that the external electronic device 210 is configured to have a function of processing the encryption information update request, the processor 200 may decrypt the encryption information included in the communication configuration message received from the external electronic device 210 based on the encryption key (e.g., the KMS key) obtained by the electronic device 101 from the KMS.

According to one embodiment, when the electronic device (e.g., the processor 120 or 200) fails to decrypt the encryption information included in the communication configuration message received from the external electronic device 210 (e.g., ‘No’ in operation 1303), in operation 1305, the electronic device may transmit the signal related to the update request to the external electronic device 210. For example, when the processor 200 fails to decrypt the encryption information included in the communication configuration message while the communication configuration message received from the external electronic device 210 includes the information indicating that the external electronic device 210 is configured to have the function of processing the encryption information update request, the processor 200 may control the communication circuit 202 to transmit the signal related to the update request to the external electronic device 210. For example, the signal related to the update request may include the “180 Ringing” with the “pck-security-refresh” included in the “Required” header.

According to one embodiment, in operation 1307, the electronic device (e.g., the processor 120 or 200) may update the encryption key of the electronic device 101. According to one embodiment, the processor 200 may update the encryption key (or the user key) through the KMS.

According to one embodiment, when the electronic device (e.g., the processor 120 or 200) succeeds in decrypting the encryption information included in the communication configuration message received from the external electronic device 210 (e.g., ‘Yes’ in operation 1303), in operation 1309, the electronic device may transmit the information related to the completion of the communication establishment to the external electronic device 210. For example, the encryption information is information required to derive the key for encrypting and/or decrypting the packet (or data) transmitted and/or received during the individual communication (or the individual call), and may include the traffic generating key (TGK) (e.g., the private call key (PCK)), the random value (RAND), the crypto session bundle identifier (CSB-ID), and/or the crypto session identifier (CS-ID).

According to one embodiment, in operation 1311, the electronic device (e.g., the processor 120 or 200) may receive the encrypted packet (e.g., SRTP) from the external electronic device 210. According to one embodiment, when the processor 200 receives the encrypted packet from the external electronic device 210, the processor 200 may decrypt the encrypted packet based on the encryption information obtained from the external electronic device 210. The processor 200 may control the output device (not illustrated) of the electronic device 101 to output the decrypted data to the outside. For example, the output device of the electronic device 101 may include the speaker and/or the display. For example, the encrypted packet may be decrypted based on the SRTP session key generated based on the encryption information (e.g., TGK (e.g., PCK), RAND, CSB-ID and/or CS-ID) to perform the individual communication (or the individual call). For example, the SRTP session key may be generated based on the SRTP master key and/or the SRTP master salt generated based on the encryption information to perform the individual communication (or the individual call).

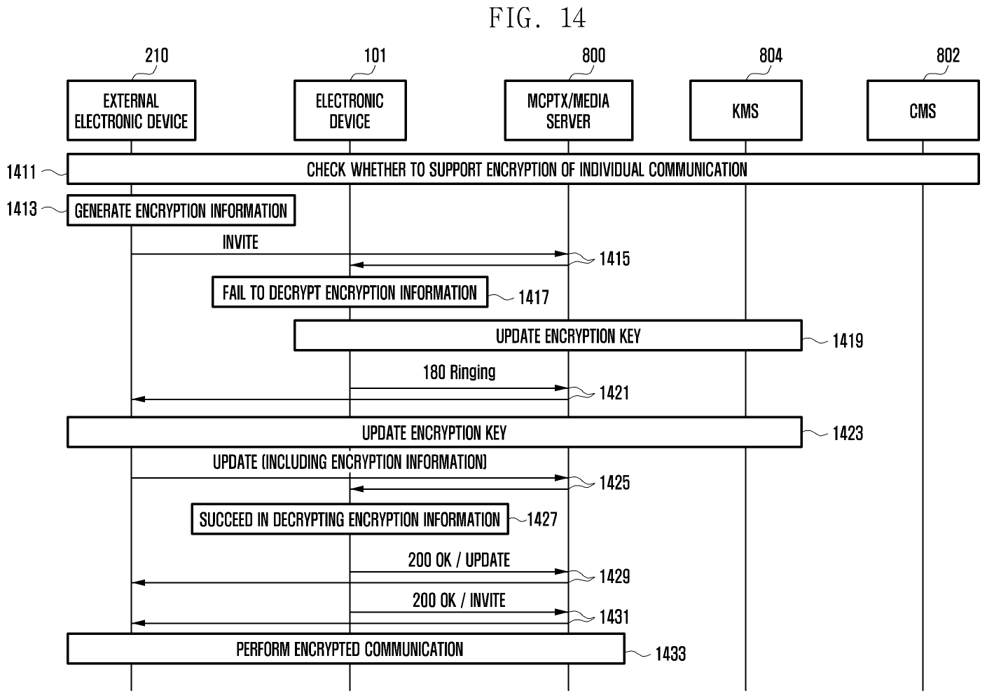

FIG. 14 is an example in which the electronic device performs the encrypted communication with the external electronic device according to an embodiment of the disclosure.

Referring to FIG. 14, the electronic device 101 may check whether the individual communication (e.g., the individual call) supports the encrypted communication in operation 1411. According to one embodiment, the electronic device 101 may check whether to support the encrypted communication of the individual communication in the user profile obtained from the configuration management server (CMS) 1401. According to one embodiment, the electronic device 101 may obtain the information related to, for example, the root certificate and/or the encryption key (or the user key) (e.g., the KMS key) from the KMS 804.

According to one embodiment, the external electronic device 210 may check whether the individual communication (or the individual call) supports the encrypted communication in operation 1411. According to one embodiment, the electronic device 101 may check whether to support the encrypted communication of the individual communication in the user profile obtained from the CMS 1401. According to one embodiment, the external electronic device 210 may obtain the information related to, for example, the root certificate and/or the encryption key (or the user key) (e.g., the KMS key) from the KMS 804.

According to one embodiment, when it is determined that the external electronic device 210 supports the encrypted communication of the individual communication, the external electronic device 210 may generate the encryption information to perform the individual communication (or the individual call) in operation 1413. For example, the encryption information is information required to derive the key for encrypting and/or decrypting the packet (or data) transmitted and/or received during the individual communication (or the individual call), and may include the traffic generating key (TGK) (e.g., the private call key (PCK)), the random value (RAND), the crypto session bundle identifier (CSB-ID), and/or the crypto session identifier (CS-ID). For example, the key for encrypting and/or decrypting the packet (or data) may include the security real-time transport protocol (SRTP) session key. For example, the SRTP session key may be generated based on the SRTP master key and/or the SRTP master salt generated based on the encryption information to perform the individual communication (or the individual call).

According to one embodiment, the external electronic device 210 may transmit the communication configuration message (e.g., INVITE) including the encryption information to the electronic device 101 through the MCPTX/media server 800 to perform the individual communication (or the individual call) with the electronic device 101 in operation 1415. For example, the encryption information may be encrypted based on the encryption key (e.g., the KMS key) obtained by the external electronic device 210 from the KMS.

According to one embodiment, the electronic device 101 may decrypt the encryption information included in the communication configuration message received from the external electronic device 210. According to one embodiment, the electronic device 101 may decrypt the encryption information included in the communication configuration message received from the external electronic device 210 based on the encryption key (e.g., the KMS key) obtained by the electronic device 101 from the KMS.

According to one embodiment, when the electronic device 101 fails to decrypt the encryption information included in the communication configuration message received from the external electronic device 210 in operation 1417, the electronic device 101 may update the encryption key of the electronic device 101 in operation 1419. According to one embodiment, the electronic device 101 may access the KMS 804 to perform the downloading of the KMC root certificate and the provisioning, thereby updating the encryption key.

According to one embodiment, when the electronic device 101 fails to decrypt the encryption information included in the communication configuration message received from the external electronic device 210 in operation 1417, the electronic device 101 may transmit the signal related to the update request to the external electronic device 210 through the MCPTX/media server 800 in operation 1421. For example, the signal related to the update request may include the “180 Ringing” with the “pck-security-refresh” included in the “Required” header.

According to one embodiment, the external electronic device 210 may update the encryption key of the external electronic device 210 based on the signal related to the update request received from the electronic device 101 in operation 1423. According to one embodiment, the external electronic device 210 may access the KMS 804 to perform the downloading of the KMC root certificate and the provisioning, thereby updating the encryption key.

According to one embodiment, the external electronic device 210 may transmit the update message (e.g., UPDATE) including the encrypted information based on the updated encryption key to the electronic device 101 through the MCPTX/media server 800 in operation 1425.

According to one embodiment, the electronic device 101 may decrypt the encryption information included in the update message received from the external electronic device 210. According to one embodiment, the electronic device 101 may decrypt the encryption information included in the update message received from the external electronic device 210 based on the updated encryption key of the electronic device 101.

According to one embodiment, when the electronic device 101 succeeds in decrypting the encryption information included in the update message received from the external electronic device 210 in operation 1427, the electronic device 101 may transmit the information (e.g., 200 OK/UPDATE) related to the success of the decryption of the encryption information to the external electronic device 210 through the MCPTX/media server 800 in operation 1429. For example, the information related to the success of the decryption of the encryption information may be transmitted to the external electronic device 210 through the MCPTX/media server 800 in response to the update message (e.g., UPDATE).

According to one embodiment, when the electronic device 101 succeeds in decrypting the encryption information included in the update message received from the external electronic device 210 in operation 1427, the electronic device 101 may transmit the response message (e.g., 200 OK/INVITE) corresponding to the communication configuration message (e.g., INVITE) to the external electronic device 210 through the MCPTX/media server 800 in operation 1431.

According to one embodiment, the electronic device 101 and the external electronic device 210 may perform the encrypted communication through the MCPTX/media server 800 in operation 1433. According to one embodiment, the external electronic device 210 may transmit the encrypted packet to the electronic device 101 through the MCPTX/media server 800. The electronic device 101 may decrypt and output the encrypted packet received from the external electronic device 210 through the MCPTX/media server 800 based on the encryption key.

According to one embodiment, the electronic device 101 may transmit the encrypted packet to the external electronic device 210 through the MCPTX/media server 800. The external electronic device 210 may decrypt and output the encrypted packet received from the electronic device 101 through the MCPTX/media server 800 based on the encryption key.

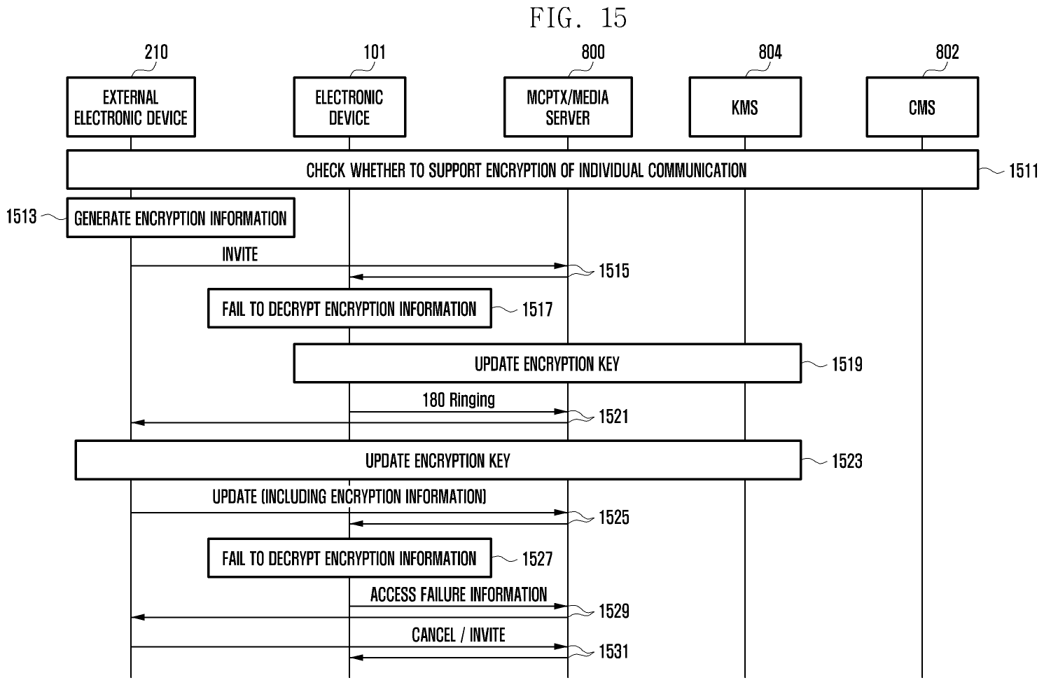

FIG. 15 is an example for updating the encryption information in the electronic device according to an embodiment of the disclosure.

Referring to FIG. 15, the electronic device 101 may check whether the individual communication (e.g., the individual call) supports the encrypted communication in operation 1511. According to one embodiment, the electronic device 101 may check whether to support the encrypted communication of the individual communication from the user profile obtained from the CMS 1401. According to one embodiment, the electronic device 101 may obtain the information related to, for example, the root certificate and/or the encryption key (or the user key) (e.g., the KMS key) from the KMS 804.

According to one embodiment, the external electronic device 210 may check whether the individual communication (or the individual call) supports the encrypted communication in operation 1511. According to one embodiment, the electronic device 101 may check whether the encrypted communication of the individual communication is supported from the user profile. According to one embodiment, the external electronic device 210 may obtain the information related to, for example, the root certificate and/or the encryption key (or the user key) (e.g., the KMS key) from the KMS 804.

According to one embodiment, when it is determined that the external electronic device 210 supports the encrypted communication of the individual communication, the external electronic device 210 may generate the encryption information to perform the individual communication (or the individual call) in operation 1513. For example, the encryption information is the information required to derive the key for encrypting and/or decrypting the packet (or data) transmitted and/or received during the individual communication (or the individual call), and may include the TGK (e.g., PCK), the RAND, the CSB-ID, and/or the CS-ID.

According to one embodiment, the external electronic device 210 may transmit the communication configuration message (e.g., INVITE) including the encryption information to the electronic device 101 through the MCPTX/media server 800 to perform the individual communication (or the individual call) with the electronic device 101 in operation 1515. For example, the encryption information may be encrypted based on the encryption key (e.g., the KMS key) obtained by the external electronic device 210 from the KMS.

According to one embodiment, the electronic device 101 may decrypt the encryption information included in the communication configuration message received from the external electronic device 210. According to one embodiment, the electronic device 101 may decrypt the encryption information included in the communication configuration message received from the external electronic device 210 based on the encryption key (e.g., the KMS key) obtained by the electronic device 101 from the KMS.

According to one embodiment, when the electronic device 101 fails to decrypt the encryption information included in the communication configuration message received from the external electronic device 210 in operation 1517, the electronic device 101 may update the encryption key of the electronic device 101 in operation 1519.

According to one embodiment, when the electronic device 101 fails to decrypt the encryption information included in the communication configuration message received from the external electronic device 210 in operation 1517, the electronic device 101 may transmit the signal related to the update request to the external electronic device 210 through the MCPTX/media server 800 in operation 1521. For example, the signal related to the update request may include the “180 Ringing” with the “pck-security-refresh” included in the “Required” header.

According to one embodiment, the external electronic device 210 may update the encryption key of the external electronic device 210 based on the signal related to the update request received from the electronic device 101 in operation 1523.

According to one embodiment, the external electronic device 210 may transmit the update message (e.g., UPDATE) including the encrypted information based on the updated encryption key to the electronic device 101 through the MCPTX/media server 800 in operation 1525. According to one embodiment, operations 1511 to 1525 of FIG. 15 are the same as the operations 1411 to 1425 of FIG. 14, and thus, a detailed description thereof may be omitted.

According to one embodiment, the electronic device 101 may decrypt the encryption information included in the update message received from the external electronic device 210. According to one embodiment, the electronic device 101 may decrypt the encryption information included in the update message received from the external electronic device 210 based on the updated encryption key of the electronic device 101.

According to one embodiment, when the electronic device 101 fails to decrypt the encryption information included in the update message received from the external electronic device 210 in operation 1527, the electronic device 101 may transmit the information (e.g., 488 Not Acceptable Here) related to the access failure to the external electronic device 210 through the MCPTX/media server 800 in operation 1529.

According to one embodiment, the external electronic device 210 may transmit the information (e.g., CANCEL/INVITE) related to the termination of the session establishment corresponding to the communication configuration message (e.g., INVITE) to the electronic device 101 through the MCPTX/media server 800 based on the information related to the access failure in operation 1531.

According to one embodiment, the electronic device 101 and the external electronic device 210 may determine that the individual communication (or individual call) is limited.

According to one embodiment, the operational method of an electronic device (e.g., the electronic device 101 of FIG. 1 or 2) may include obtaining, from the server, the encryption information related to the group including the electronic device. According to one embodiment, the operational method of an electronic device may include checking whether the group provides the encrypted communication when the unencrypted packet is received from the external electronic device included in the group. According to one embodiment, the operational method of an electronic device may include transmitting the request signal related to updating the encryption information to the external electronic device when it is determined that the group provides the encrypted communication. According to one embodiment, the operational method of an electronic device may include receiving the encrypted packet from the external electronic device when the signal related to the completion of updating the encryption information is received from the external electronic device.

According to one embodiment, the operational method of an electronic device may include determining that the packet received from the external electronic device is unencrypted packet when the packet received from the external electronic device does not include the master key identifier (MKI).

According to one embodiment, the operational method of an electronic device may include determining that the packet received from the external electronic device is encrypted packet when the packet received from the external electronic device includes the MKI, and decrypting the encrypted packet received from the external electronic device based on the encryption information when the encrypted packet is received from the external electronic device included in the group.

According to one embodiment, the operational method of an electronic device may include updating the encryption key related to the group through the server when it is determined that the group including the electronic device provides the encrypted communication, and updating the encryption information related to the group through a server.

According to one embodiment, the operational method of an electronic device may include decrypting the encrypted packet received from the external electronic device based on the updated encryption information.

According to one embodiment, the operational method of an electronic device may include outputting the information related to receiving the unencrypted packet to the outside when the signal related to the failure to update the encryption information from the external electronic device is received, and outputting the unencrypted packet received from the external electronic device when the input related to the performance of the unencrypted communication is detected based on the output information.

According to one embodiment, the operational method of an electronic device may include checking whether the menu related to receiving the unencrypted packet is configured when the signal related to the failure to update the encryption information is received from the external electronic device, and outputting the unencrypted packet received from the external electronic device when the menu related to receiving the unencrypted packet is configured.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a communication circuit;
memory, comprising one or more storage media, storing instructions; and
at least one processor operatively connected to the communication circuit and the memory,
wherein the instructions, when executed by the at least one processor individually or collectively, cause the electronic device to:
obtain, via the communication circuit from a server, encryption information related to a group including the electronic device,
when an unencrypted packet is received from an external electronic device included in the group, check whether the group provides encrypted communication,
when the group provides the encrypted communication, transmit, to the external electronic device, a request signal related to updating the encryption information, and
when a signal related to a completion of updating the encryption information is received from the external electronic device, receive an encrypted packet from the external electronic device.

2. The electronic device of claim 1, wherein the encryption information includes information related to a security real time protocol (SRTP) session key.

3. The electronic device of claim 1, wherein the encryption information includes at least one of a traffic generating key (TGK), a random value (RAND), a crypto session bundle identifier (CSB-ID), or a crypto session identifier (CS-ID).

4. The electronic device of claim 1, wherein the instructions, when executed by the at least one processor individually or collectively, further cause the electronic device to:
when a packet received from the external electronic device does not include a master key identifier (MKI), determine that the packet received from the external electronic device is the unencrypted packet, and
when the packet received from the external electronic device includes the MKI, determine that the packet received from the external electronic device is the encrypted packet.

5. The electronic device of claim 1, wherein the instructions, when executed by the at least one processor individually or collectively, further cause the electronic device to, when the group including the electronic device provides the encrypted communication:
update an encryption key related to the group through the server, and
update the encryption information related to the group through the server.

6. The electronic device of claim 1, further comprising:
an output device,
wherein the instructions, when executed by the at least one processor individually or collectively, further cause the electronic device to:
when a signal related to a failure to update the encryption information is received from the external electronic device, output information related to receiving the unencrypted packet to an outside through the output device, and
when an input related to performance of unencrypted communication is detected based on the outputted information, output the unencrypted packet received from the external electronic device to the outside through the output device.

7. The electronic device of claim 1, further comprising:
an output device,
wherein the instructions, when executed by the at least one processor individually or collectively, further cause the electronic device to:
when a signal related to a failure to update the encryption information is received from the external electronic device, check whether a menu related to receiving the unencrypted packet is configured, and
when the menu related to receiving the unencrypted packet is configured, output the unencrypted packet received from the external electronic device to an outside through the output device.

8. The electronic device of claim 1, wherein the instructions, when executed by the at least one processor individually or collectively, further cause the electronic device to:
decrypt encryption information obtained from a grouping management server (GMS) based on an encryption key obtained from a key management server (KMS) to obtain the encryption information related to the group including the electronic device.

9. A method performed by an electronic device, the method comprising:
obtaining, from a server, encryption information related to a group including the electronic device;
when an unencrypted packet is received from an external electronic device included in the group, checking whether the group provides encrypted communication;
when the group provides the encrypted communication, transmitting, to the external electronic device, a request signal related to updating the encryption information; and
when a signal related to a completion of updating the encryption information is received from the external electronic device, receiving an encrypted packet from the external electronic device.

10. The method of claim 9, wherein the encryption information includes information related to a security real time protocol (SRTP) session key.

11. The method of claim 9, wherein the encryption information includes at least one of a traffic generating key (TGK), a random value (RAND), a crypto session bundle identifier (CSB-ID), or a crypto session identifier (CS-ID).

12. The method of claim 9, further comprising:
when a packet received from the external electronic device does not include a master key identifier (MKI), determining that the packet received from the external electronic device is the unencrypted packet, and
when the packet received from the external electronic device includes the MKI, determining that the packet received from the external electronic device is the encrypted packet.

13. The method of claim 9, further comprising:
when the group including the electronic device provides the encrypted communication, updating an encryption key related to the group through the server; and
updating the encryption information related to the group through the server.

14. The method of claim 9, further comprising:
when a signal related to a failure to update the encryption information is received from the external electronic device, outputting information related to receiving the unencrypted packet to an outside; and
when an input related to performance of an unencrypted communication is detected based on the outputted information, outputting the unencrypted packet received from the external electronic device.

15. The method of claim 9, further comprising:
when a signal related to a failure to update the encryption information is received from the external electronic device, checking whether a menu related to receiving the unencrypted packet is configured; and
when the menu related to receiving the unencrypted packet is configured, outputting the unencrypted packet received from the external electronic device.

16. The method of claim 9, further comprising:
decrypting encryption information obtained from a grouping management server (GMS) based on an encryption key obtained from a key management server (KMS) to obtain the encryption information related to the group including the electronic device.

17. One or more non-transitory computer-readable storage media storing one or more computer programs including computer-executable instructions that, when executed by one or more processors of an electronic device individually or collectively, cause the electronic device to perform operations, the operations comprising:
obtaining, from a server, encryption information related to a group including the electronic device;
when an unencrypted packet is received from an external electronic device included in the group, checking whether the group provides encrypted communication;
when the group provides the encrypted communication, transmitting, to the external electronic device, a request signal related to updating the encryption information; and
when a signal related to a completion of updating the encryption information is received from the external electronic device, receiving an encrypted packet from the external electronic device.

18. The one or more non-transitory computer-readable storage media of claim 17, the operations further comprising:
when a packet received from the external electronic device does not include a master key identifier (MKI), determining that the packet received from the external electronic device is the unencrypted packet, and
when the packet received from the external electronic device includes the MKI, determining that the packet received from the external electronic device is the encrypted packet.
